(19) United States
(12) Patent Application Publication
(10) Pub. No.: US 2015/0060745 A1
(43) Pub. Date: Mar. 5, 2015

(54) PHOTOSENSITIVE RESIN COMPOSITION FOR BLACK MATRIX AND USES THEREOF

(71) Applicant: Chi Mei Corporation, Tainan City (TW)

(72) Inventors: Hao-Wei Liao, Kaohsiung City (TW); Li-Ting Hsieh, Tainan City (TW)

(21) Appl. No.: 14/462,586

(22) Filed: Aug. 19, 2014

(30) Foreign Application Priority Data
Aug. 28, 2013 (TW) 102130844

(51) Int. Cl. G02B 1/04; G02F 1/1335; G02B 5/23

(52) U.S. Cl. CPC G02B 1/04; G02B 5/23; G02F 1/133514
USPC 252/586

(57) ABSTRACT

A photosensitive resin composition for a black matrix including an alkali-soluble resin (A), a compound (B) having an ethylenically unsaturated group, a photoinitiator (C), a solvent (D), a black pigment (E), a cross-linking agent (F), and an inorganic particle is provided. The alkali-soluble resin (A) includes a resin (A-1) having an unsaturated group, wherein the resin (A-1) having an unsaturated group is obtained by polymerizing a mixture including an epoxy compound having at least two epoxy groups and a compound having at least one carboxylic acid group and at least one ethylenically unsaturated group. The cross-linking agent (F) includes a cross-linking agent (F-1) obtained by reacting a novolac resin represented by formula (f-1) and an epihalohydrin under an existence of an alkali metal hydroxides. The inorganic particle employs oxides of a Group 4 element, oxides of silicone, or a combination thereof to serve as the major component.

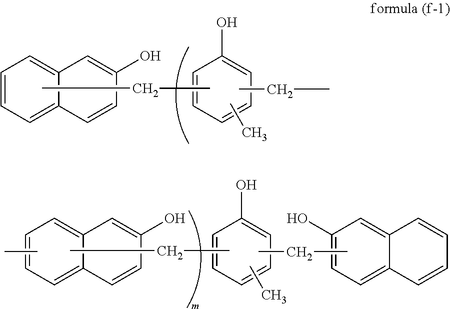

### CROSS-REFERENCE TO RELATED APPLICATION

This application claims the priority benefit of Taiwan application serial no. 102130844, filed on Aug. 28, 2013. The entirety of the above-mentioned patent application is hereby incorporated by reference herein and made a part of this specification.

### BACKGROUND OF THE INVENTION

1. Field of the Invention

The invention relates to a photosensitive resin composition, and more particularly, to a photosensitive resin composition for a black matrix.

2. Description of Related Art

Recently, with the development of various Liquid Crystal Display (LCD) technologies, in order to increase the contrast and the display quality of the current LCD, a black matrix is generally disposed in the gap of the stripes and the dots of the color filter in the LCD. The black matrix can prevent issues such as decrease in contract ratio and decrease in color purity caused by light leakage between pixels.

The material used by the black matrix is generally an evaporated film containing chromium or chromium oxide. However, when using the evaporated film as the material of the black matrix, disadvantages such as complex process and expensive material exist. To solve the issues, a method of forming a black matrix by using a photosensitive resin composition through photo lithography has previously been proposed.

With the rising demand for the light-shielding property of the black matrix, one of the solutions has been to increase the usage amount of the black pigment to increase the light-shielding property of the black matrix. For instance, JP-A 2006-259716 discloses a photosensitive resin composition for a black matrix containing a high usage amount of a black pigment, an alkali-soluble resin, a photopolymerization initiator, a reactive monomer having a difunctional group, and an organic solvent. It should be mentioned that, the reactive monomer having a difunctional group can improve the reaction between compounds to form a fine pattern. As a result, when increasing the light-shielding property in the photosensitive resin composition by increasing the usage amount of the black pigment, the sensitivity of the photosensitive resin composition can still be maintained.

Moreover, JP-A 2008-268854 discloses a photosensitive resin composition for a black matrix. The photosensitive resin composition contains an alkali-soluble resin having a carboxylic acid group and an unsaturated group, a photopolymerizable monomer having an ethylenically unsaturated group, a photopolymerization initiator, and a black pigment with a high usage amount. In the photosensitive resin composition for a black matrix, a specific alkali-soluble resin is used to improve the resolution of the photosensitive resin composition having a high usage amount of black pigment.

Although the current techniques can increase the light-shielding property of the photosensitive resin composition by increasing the usage amount of the black pigment, the known photosensitive resin compositions still have the issue of low surface resistance. Accordingly, a photosensitive resin composition for a black matrix having high surface resistance still needs to be developed.

### SUMMARY OF THE INVENTION

The invention provides a photosensitive resin composition for a black matrix having high surface resistance and a black matrix formed thereby.

The invention provides a photosensitive resin composition for a black matrix. The photosensitive resin composition for a black matrix includes an alkali-soluble resin (A), a compound (B) having an ethylenically unsaturated group, a photoinitiator (C), a solvent (D), a black pigment (E), a cross-linking agent (F), and an inorganic particle (G). The alkali-soluble resin (A) includes a resin (A-1) having an unsaturated group, wherein the resin (A-1) having an unsaturated group is obtained by polymerizing a mixture including an epoxy compound (a-1-1) having at least two epoxy groups and a compound (a-1-2) having at least one carboxylic acid group and at least one ethylenically unsaturated group. The cross-linking agent (F) includes a cross-linking agent (F-1), wherein the cross-linking agent (F-1) is obtained by reacting a novolac resin represented by formula (f-1) and epihalohydrin under an existence of an alkali metal hydroxide. The inorganic particle (G) employs oxides of a Group 4 element, oxides of silicone, or a combination thereof to serve as the major component.

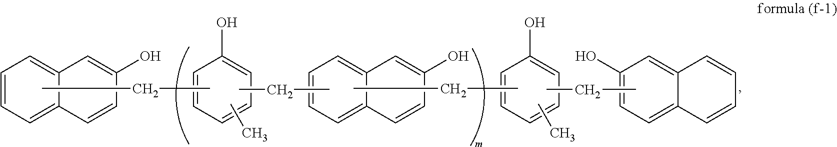

in formula (f-1), m represents an integer of 0 to 7.

In an embodiment of the invention, the epoxy compound (a-1-1) having at least two epoxy groups includes the structure shown in formula (a-1), the structure shown in formula (a-2), or a combination of the two structures,

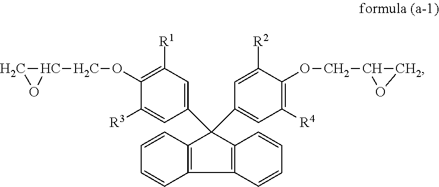

in formula (a-1), R¹, R², R³, and R⁴ each independently represent a hydrogen atom, a halogen atom, a C₁-C₅ alkyl group, a C₁-C₅ alkoxy group, a C₆-C₁₂ aryl group, or a C₆-C₁₂ aralkyl group.

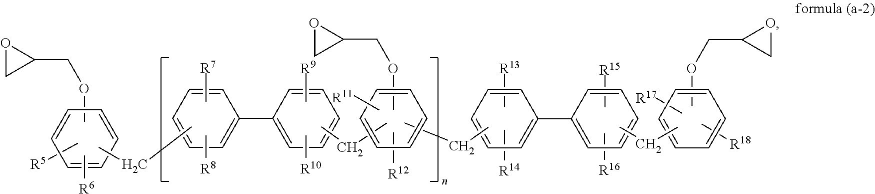

in formula (a-2), R⁵ to R¹⁸ each independently represent a hydrogen atom, a halogen atom, a C₁-C₈ alkyl group, or a C₆-C₁₅ aromatic group, and n represents an integer of 0 to 10.

In an embodiment of the invention, based on a usage amount of 100 parts by weight of the alkali-soluble resin (A), the usage amount of the compound (B) having an ethylenically unsaturated group is 15 to 180 parts by weight, the usage amount of the photoinitiator (C) is 5 to 60 parts by weight, the usage amount of the solvent (D) is 1,000 to 5,000 parts by weight, the usage amount of the black pigment (E) is 100 to 800 parts by weight, the usage amount of the cross-linking agent (F) is 2 to 30 parts by weight, and the usage amount of the inorganic particle (G) is 3 to 30 parts by weight.

In an embodiment of the invention, based on a usage amount of 100 parts by weight of the alkali-soluble resin (A), the usage amount of the cross-linking agent (F-1) is 2 to 20 parts by weight.

The invention further provides a black matrix. The black matrix is formed by using the photosensitive resin composition for a black matrix.

The invention also provides a color filter. The color filter includes the black matrix.

The invention further provides a liquid crystal display. The liquid crystal display includes the color filter.

Based on the above, in the photosensitive resin composition for a black matrix of the invention, by including the resin (A-1) having an unsaturated group, the cross-linking agent (F), and the inorganic particle (G), current issues of the photosensitive resin composition for a black matrix such as insufficient surface resistance can be effectively improved.

To make the above features and advantages of the invention more comprehensible, several embodiments are described in detail as follows.

### DESCRIPTION OF THE EMBODIMENTS

### <Photosensitive Resin Composition for Black Matrix>

The invention provides a photosensitive resin composition for a black matrix. The photosensitive resin composition for a black matrix includes an alkali-soluble resin (A), a compound (B) having an ethylenically unsaturated group, a photoinitiator (C), a solvent (D), a black pigment (E), a cross-linking agent (F), and an inorganic particle (G). Moreover, the photosensitive resin composition for a black matrix can further include an additive (H) if needed. In the following, the individual components used in the photosensitive resin composition for a black matrix of the invention are described in detail.

It should be mentioned that, in the following, (meth)acrylic acid represents acrylic acid and/or methacrylic acid, and (meth)acrylate represents acrylate and/or methacrylate. Similarly, (meth)acryloyl represents acryloyl and/or methacryloyl.

### Alkai-Soluble Resin (A)

The alkali-soluble resin (A) includes a resin (A-1) having an unsaturated group. Moreover, the alkali-soluble resin (A) can optionally include other alkai-soluble resins (A-2).

### Resin (A-1) Having an Unsaturated Group

The resin (A-1) having an unsaturated group is obtained by polymerizing a mixture. The mixture includes an epoxy compound (a-1-1) having at least two epoxy groups and a compound (a-1-2) having at least one carboxylic acid group and at least one ethylenically unsaturated group. Moreover, the mixture can further include a carboxylic acid anhydride compound (a-1-3), a compound (a-1-4) having an epoxy group, or a combination of the two compounds.

Epoxy Compound (a-1-1) Having at Least Two Epoxy Groups

The epoxy compound (a-1-1) having at least two epoxy groups includes the structure shown in formula (a-1), the structure shown in formula (a-2), or a combination of the two structures. Each of the structures represented by formula (a-1) and formula (a-2) is described below.

Specifically, the structure represented by formula (a-1) is as follows:

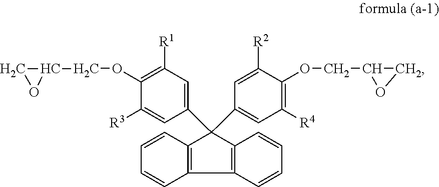

in formula (a-1), R¹, R², R³, and R⁴ each independently represent a hydrogen atom, a halogen atom, a C₁-C₅ alkyl group, a C₁-C₅ alkoxy group, a C₆-C₁₂ aryl group, or a C₆-C₁₂ aralkyl group.

The epoxy compound (a-1-1) having at least two epoxy groups containing the structure represented by formula (a-1) can include a bisphenol fluorene-type compound having an epoxy group obtained by reacting a bisphenol fluorene compound and epihalohydrin.

Specifically, specific examples of the bisphenol fluorene-type compound include 9,9-bis(4-hydroxyphenyl)fluorene, 9,9-bis(4-hydroxy-3-methylphenyl)fluorene, 9,9-bis(4-hydroxy-3-chlorophenyl)fluorene, 9,9-bis(4-hydroxy-3-bromophenyl)fluorene, 9,9-bis(4-hydroxy-3-fluorophenyl)fluorene, 9,9-bis(4-hydroxy-3-methoxyphenyl)fluorene, 9,9-bis (4-hydroxy-3,5-dimethylphenyl)fluorene, 9,9-bis(4-hydroxy-3,5-dichlorophenyl)fluorene, 9,9-bis(4-hydroxy-3,5-dibromophenyl)fluorene, or a similar compound thereof, or a combination of the compounds.

Specific examples of the epihalohydrin include epichlorohydrin, epibromohydrin, or a similar compound thereof, or a combination of the compounds.

Specific examples of the bisphenol fluorene-type compound having an epoxy group include (1) products made by Nippon Steel Chemical Co., Ltd. such as ESF-300 or a similar compound thereof; (2) products made by Osaka Gas Co., Ltd. such as PG-100, EG-210, or a similar compound thereof; or (3) products made by S.M.S. Technology Co. such as SMS-F9PhPG, SMS-F9CrG, SMS-F914PG, or a similar compound thereof.

Moreover, specifically, the structure represented by formula (a-2) is as follows:

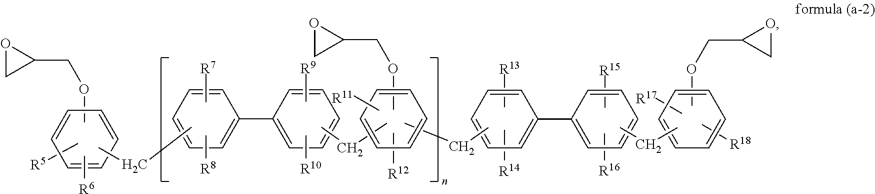

in formula (a-2), R⁵ to R¹⁸ each independently represent a hydrogen atom, a halogen atom, a C₁-C₈ alkyl group, or a C₆-C₁₅ aromatic group, and n represents an integer of 0 to 10.

The epoxy compound (a-1-1) having at least two epoxy groups containing the structure represented by formula (a-2) can be obtained by reacting a compound having the structure of formula (a-2-1) and epihalohydrin under an existence of an alkali metal hydroxide.

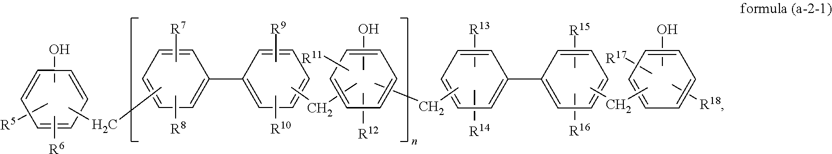

in formula (a-2-1), the definition of each of R⁵ to R¹⁸ and n is the same as the definition of each of R⁵ to R¹⁸ and n in formula (a-2), and is not repeated herein.

The synthesis method of the epoxy compound (a-1-1) having at least two epoxy groups containing the structure represented by formula (a-2) is as follows: first, a condensation reaction is performed between a compound having the structure of formula (a-2-2) and a phenol under an existence of an acid catalyst to form a compound having the structure of formula (a-2-1). Then, an excessive amount of epihalohydrin is added to perform dehydrohalogenation on the epihalohydrin and the compound having the structure of formula (a-2-1) to obtain the epoxy compound (a-1-1) having at least two epoxy groups containing the structure represented by formula (a-2).

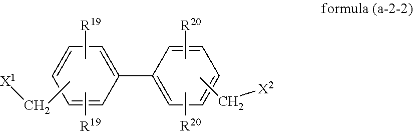

In formula (a-2-2), R¹⁹ and R²⁰ each independently represent a hydrogen atom, a halogen atom, a C₁-C₈ alkyl group, or a C₆-C₁₅ aromatic group; X¹ and X² each independently represent a halogen atom, a C₁-C₆ alkyl group, or a C₁-C₆ alkoxy group. The halogen atom is preferably chlorine or bromine. The alkyl group is preferably a methyl group, an ethyl group, or tertiary butyl. The alkoxy group is preferably a methoxy group or an ethoxy group.

Specific examples of the phenol include phenol, cresol, ethylphenol, n-propylphenol, isobutylphenol, t-butylphenol, octylphenol, nonylphenol, xylenol, methylbutylphenol, di-t-butylphenol, vinylphenol, propenylphenol, ethinylphenol, cyclopentylphenol, cyclohexylphenol, cyclohexylcresol, or a similar compound thereof. The phenol can be used alone or in multiple combinations.

Based on a usage amount of 1 mole of the compound having the structure of formula (a-2-2), the usage amount of phenol is 0.5 moles to 20 moles and preferably 2 moles to 15 moles.

Specific examples of the acid catalyst include hydrochloric acid, sulfuric acid, p-toluenesulfonic acid, oxalic acid, boron trifluoride, aluminium chloride anhydrous, zinc chloride, or a similar compound thereof. The acid catalyst is preferably p-toluenesulfonic acid, sulfuric acid, hydrochloric acid, or a combination of the compounds. The acid catalyst can be used alone or in multiple combinations.

Moreover, the usage amount of the acid catalyst is not particularly limited. However, based on a usage amount of 100 weight percent (wt %) of the compound having the structure of formula (a-2-2), the usage amount of the acid catalyst is preferably 0.1 wt % to 30 wt %.

The condensation reaction can be performed without a solvent or under an existence of an organic solvent. Moreover, specific examples of the organic solvent include toluene, xylene, methyl isobutyl ketone, or a similar compound thereof. The organic solvent can be used alone or in multiple combinations.

Based on a total weight of 100 wt % of the compound having the structure of formula (a-2-2) and the phenol, the usage amount of the organic solvent is 50 wt % to 300 wt % and preferably 100 wt % to 250 wt %. Moreover, the operating temperature of the condensation reaction is 40° C. to 180° C. and the operating time of the condensation reaction is 1 hour to 8 hours.

After the condensation reaction is complete, a neutralization treatment or a rinse treatment can be performed. In the neutralization treatment, the pH of the reacted solution is adjusted to pH 3 to pH 7, and preferably pH 5 to pH 7. The rinse treatment can be performed by using a neutralizer, wherein the neutralizer is an alkaline substance, and specific examples thereof include alkali metal hydroxides such as sodium hydroxide, potassium hydroxide, or a similar compound thereof; alkaline earth metal hydroxides such as calcium hydroxide, magnesium hydroxide, or a similar compound thereof; organic amines such as diethylene triamine, triethylenetetramine, aniline, phenylene diamine, or a similar compound thereof; ammonia, sodium dihydrogen phosphate, or a combination of the compounds. The neutralizing agent can be used alone or in multiple combinations. The rinse treatment can be performed with a known method, such as adding an aqueous solution containing a neutralizer in the reacted solution and then extracting repeatedly. After the neutralization treatment or the rinse treatment, the unreacted phenol and solvent can be distilled off through a heat treatment under reduced pressure, and then condensation is performed to obtain the compound having the structure of formula (a-2-1).

Specific examples of the epihalohydrin include epichlorohydrin (3-chloro-1,2-epoxypropane), epibromohydrin (3-bromo-1,2-epoxypropane), or a similar compound thereof, or a combination of the compounds. Before the dehydrohalogenation reaction is performed, an alkali metal hydroxide such as sodium hydroxide and potassium hydroxide can be pre-added or added during the reaction process. The operating temperature of the dehydrohalogenation reaction is 20° C. to 120° C. and the range of the operating time thereof is 1 hour to 10 hours.

In an embodiment, the alkali metal hydroxide added in the dehydrohalogenation reaction can also be an aqueous solution thereof. In the present embodiment, when the aqueous solution of alkali metal hydroxide is continuously added in the dehydrohalogenation reaction system, water and epihalohydrin can be continuously distilled under reduced pressure or normal pressure to separate and remove water, and epihalohydrin can be continuously flown back to the reaction system.

Before the dehydrohalogenation reaction is performed, a quaternary ammonium salt such as tetramethyl ammonium chloride, tetramethyl ammonium bromide, trimethyl benzyl ammonium chloride, or a similar compound thereof can also be added as a catalyst, and then an alkali metal hydroxide or an aqueous solution thereof is added after reacting for 1 hour to 5 hours at 50° C. to 150° C. Then, the mixture is reacted for 1 hour to 10 hours at 20° C. to 120° C. to perform the dehydrohalogenation reaction.

Based on a total equivalent of 1 equivalent of the hydroxyl group of the compound having the structure of formula (a-2-1), the usage amount of the epihalohydrin is 1 equivalent to 20 equivalents and preferably 2 equivalents to 10 equivalents. Based on a total equivalent of 1 equivalent of the hydroxyl group of the compound having the structure of formula (a-2-1), the usage amount of the alkali metal hydroxide added in the dehydrohalogenation reaction is 0.8 equivalents to 15 equivalents and preferably 0.9 equivalents to 11 equivalents.

Moreover, to perform the dehydrohalogenation reaction smoothly, an alcohol such as methanol, ethanol, or a similar compound thereof can also be added. In addition, an aprotic polar solvent such as dimethyl sulfone, dimethyl sulfoxide, or a similar compound thereof can also be added to perform the reaction. When alcohol is used, based on a total amount of 100 wt % of the epihalohydrin, the usage amount of the alcohol is 2 wt % to 20 wt % and preferably 4 wt % to 15 wt %. When an aprotic polar solvent is used, based on a total amount of 100 wt % of the epihalohydrin, the usage amount of the aprotic polar solvent is 5 wt % to 100 wt % and preferably 10 wt % to 90 wt %.

After the dehydrohalogenation reaction is complete, a rinse treatment can be optionally performed. Then, the epihalohydrin, the phenol, and the aprotic polar solvent are removed by using a method of heating under reduced pressure such as at a temperature of 110° C. to 250° C. and a pressure lower than 1.3 kPa (10 mmHg).

To prevent the epoxy resin formed from containing a hydrolyzable halogen, the solution after the dehydrohalogenation reaction can be added in a solvent such as toluene and methyl isobutyl ketone and an aqueous alkali metal hydroxide such as sodium hydroxide and potassium hydroxide, and then the dehydrohalogenation reaction is performed again. In the dehydrohalogenation reaction, based on a total equivalent of 1 equivalent of the hydroxyl group in the compound having the structure of formula (a-2-1), the usage amount of the alkali metal hydroxide is 0.01 moles to 0.3 moles and preferably 0.05 moles to 0.2 moles. Moreover, the range of the operating temperature of the dehydrohalogenation reaction is 50° C. to 120° C. and the range of the operating time thereof is 0.5 hours to 2 hours.

After the dehydrohalogenation reaction is complete, the salts are removed through steps such as filtering and rinsing. Moreover, solvents such as toluene and methyl isobutyl ketone can be distilled off through a method of heating under reduced pressure to obtain the epoxy compound (a-1-1) having at least two epoxy groups containing the structure represented by formula (a-2). Specific examples of the epoxy compound (a-1-1) having at least two epoxy groups containing the structure represented by formula (a-2) include products such as NC-3000, NC-3000H, NC-3000S, or NC-3000P made by Nippon Kayaku Co., Ltd.

Compound (a-1-2) Having at Least One Carboxylic Acid Group and at Least One Ethylenically Unsaturated Group

The compound (a-1-2) having at least one carboxylic acid group and at least one ethylenically unsaturated group is selected from one of the following groups (1) to (3):

(1) acrylate, methacrylate, 2-methacryloyloxyethylbutanedioic acid, 2-methacryloyloxybutylbutanedioic acid, 2-methacryloyloxyethylhexanedioic acid, 2-methacryloyloxybutylhexanedioic acid, 2-methacryloyloxyethylhexahydrophthalic acid, 2-methacryloyloxyethylmaleic acid, 2-methacryloyloxypropylmaleic acid, 2-methacryloyloxybutylmaleic acid, 2-methacryloyloxypropylbutanedioic acid, 2-methacryloyloxypropylhexanedioic acid, 2-methacryloyloxypropyltetrahydrophthalic acid, 2-methacryloyloxypropylphthalic acid, 2-methacryloyloxybutylphthalic acid, 2-methacryloyloxybutylhydrophthalic acid, or a similar compound thereof;

(2) a compound obtained by reacting (meth)acrylate having a hydroxyl group and a dicarboxylic acid compound, wherein specific examples of the dicarboxylic acid compound include hexanedioic acid, butanedioic acid, maleic acid, phthalic acid, or a similar compound thereof and

(3) a half ester compound obtained by reacting (meth)acrylate having a hydroxyl group and the carboxylic acid anhydride compound (a-1-3), wherein specific examples of the (meth)acrylate having a hydroxyl group include (2-hydroxyethyl)acrylate, (2-hydroxyethyl)methacrylate, (2-hydroxypropyl)acrylate, (2-hydroxypropyl)methacrylate, (4-hydroxybutyl)acrylate, (4-hydroxybutyl)methacrylate, pentaerythritol trimethacrylate, or a similar compound thereof Moreover, the carboxylic acid anhydride compound can be the same as the carboxylic acid anhydride compound (a-1-3) contained in the mixture of the resin (A-1) having an unsaturated group, and is therefor not repeated herein.

Carboxylic Acid Anhydride Compound (a-1-3)

The carboxylic acid anhydride compound (a-1-3) can be selected from one of the following groups (1) to (2):

(1) dicarboxylic acid anhydride compounds such as butanedioic anhydride, maleic anhydride, itaconic anhydride, phthalic anhydride, tetrahydrophthalic anhydride, hexahydrophthalic anhydride, methyl tetrahydrophthalic anhydride, methyl hexahydrophthalic anhydride, methyl endo-methylene tetrahydrophthalic anhydride, chlorendic anhydride, glutaric anhydride, 1,3-dioxoisobenzofuran-5-carboxylic acid anhydride, or a similar compound thereof; and

(2) tetracarboxylic acid anhydride compounds such as benzophenone tetracarboxylic dianhydride (BTDA), dibenzenetetracarboxylic dianhydride, diphenyl ether tetracarboxylic dianhydride, or a similar compound thereof.

Compound (a-1-4) Having an Epoxy Group

Specific examples of the compound (a-1-4) having an epoxy group include glycidyl methacrylate, 3,4-epoxycyclohexyl methacrylate, a glycidyl ether compound having an unsaturated group, an unsaturated compound having an epoxy group, or a combination of the compounds. Specific examples of the glycidyl ether compound having an unsaturated group include Denacol EX-111, EX-121 Denacol, Denacol EX-141, Denacol EX-145, Denacol EX-146, Denacol EX-171, or Denacol EX-192 (products of Nagase ChemteX Corporation).

The resin (A-1) having an unsaturated group can be obtained by polymerizing the epoxy compound (a-1-1) having at least two epoxy groups containing the structure represented by formula (a-1) and the compound (a-1-2) having at least one carboxylic acid group and at least one ethylenically unsaturated group to form a reaction product having a hydroxyl group, followed by adding the carboxylic acid anhydride compound (a-1-3) to perform a reaction. Based on a total equivalent of 1 equivalent of the hydroxyl group of the reaction product having a hydroxyl group, the equivalent of the anhydride group contained in the carboxylic acid anhydride compound (a-1-3) is preferably 0.4 equivalents to 1 equivalent, and more preferably 0.75 equivalents to 1 equivalent. When a plurality of the carboxylic acid anhydride compounds (a-1-3) are used, the plurality of carboxylic acid anhydride compounds (a-1-3) can be added in the reaction in sequence or at the same time. When a dicarboxylic acid anhydride compound and a tetracarboxylic acid anhydride compound are used as the carboxylic acid anhydride compound (a-1-3), the molar ratio of the dicarboxylic acid anhydride compound to the tetracarboxylic acid anhydride compound is preferably 1/99 to 90/10, and more preferably 5/95 to 80/20. Moreover, the range of the operating temperature of the reaction is 50° C. to 130° C.

The resin (A-1) having an unsaturated group can be obtained by reacting the epoxy compound (a-1-1) having at least two epoxy groups containing the structure represented by formula (a-2) and the compound (a-1-2) having at least one carboxylic acid group and at least one ethylenically unsaturated group to form a reaction product having a hydroxyl group, followed by adding the carboxylic acid anhydride compound (a-1-3) and/or the compound (a-1-4) having an epoxy group to perform a polymerization reaction. Based on a total equivalent of 1 equivalent of the epoxy compound (a-1-1) having at least two epoxy groups containing the structure represented by formula (a-2), the equivalent of the acid value of the compound (a-1-2) having at least one carboxylic acid group and at least one ethylenically unsaturated group is preferably 0.8 equivalents to 1.5 equivalents, and more preferably 0.9 equivalents to 1.1 equivalents. Based on a total amount of 100 mole percent (mole %) of the hydroxyl group of the reaction product having a hydroxyl group, the usage amount of the carboxylic acid anhydride compound (a-1-3) is 10 mole % to 100 mole %, preferably 20 mole % to 100 mole %, and more preferably 30 mole % to 100 mole %.

When preparing the resin (A-1) having an unsaturated group, to speed up the reaction, an alkali compound is generally added in the reaction solution as a reaction catalyst. Specific examples of the reaction catalyst include, for instance, triphenyl phosphine, triphenyl stibine, triethylamine, triethanolamine, tetramethylammonium chloride, or benzyltriethylammonium chloride. The reaction catalyst can be used alone or in multiple combinations. Based on a total weight of 100 parts by weight of the epoxy compound (a-1-1) having at least two epoxy groups and the compound (a-1-2) having at least one carboxylic acid group and at least one ethylenically unsaturated group, the usage amount of the reaction catalyst is preferably 0.01 parts by weight to 10 parts by weight and more preferably 0.3 parts by weight to 5 parts by weight.

Moreover, to control the degree of polymerization, an inhibitor is generally added in the reaction solution. Specific examples of the inhibitor include methoxyphenol, methylhydroquinone, hydroquinone, 2,6-di-t-butyl-p-cresol, phenothiazine, or a similar compound thereof. The inhibitor can generally be used alone or in multiple combination. Based on a total weight of 100 parts by weight of the epoxy compound (a-1-1) having at least two epoxy groups and the compound (a-1-2) having at least one carboxylic acid group and at least one ethylenically unsaturated group, the usage amount of the inhibitor is 0.01 parts by weight to 10 parts by weight and preferably 0.1 parts by weight to 5 parts by weight.

When preparing the resin (A-1) having an unsaturated group, a polymerization reaction solvent can be used when needed. Specific examples of the polymerization reaction solvent include alcohol compounds such as ethanol, propanol, isopropanol, butanol, isobutanol, 2-butanol, hexanol, ethylene glycol, or a similar compound thereof; ketone compounds such as methyl ethyl ketone, cyclohexanone, or a similar compound thereof; aromatic hydrocarbon compounds such as toluene, xylene, or a similar compound thereof; cellosolve compounds such as cellosolve, butyl cellosolve, or a similar compound thereof; carbitol compounds such as carbitol, butyl carbitol, or a similar compound thereof; propylene glycol alkyl ether compounds such as propylene glycol monomethyl ether or a similar compound thereof; poly(propylene glycol) alkyl ether compounds such as di(propylene glycol) methyl ether or a similar compound thereof; acetic acid ester compounds such as ethyl acetate, butyl acetate, ethylene glycol monoethyl ether acetate, propylene glycol monomethyl ether acetate, or a similar compound thereof; alkyl lactate compounds such as ethyl lactate, butyl lactate, or a similar compound thereof; or dialkyl glycol ethers. The polymerization reaction solvent can be used alone or in multiple combinations. Moreover, the acid value of the resin (A-1) having an unsaturated group is 50 mgKOH/g to 200 mgKOH/g and preferably 60 mgKOH/g to 150 mgKOH/g.

Based on a usage amount of 100 parts by weight of the alkai-soluble resin (A-1), the usage amount of the resin (A-1) having an unsaturated group is 30 parts by weight to 100 parts by weight, preferably 50 parts by weight to 100 parts by weight, and more preferably 70 parts by weight to 100 parts by weight.

It should be mentioned that, when the resin (A-1) having an unsaturated group is not used, in the photosensitive resin composition for a black matrix, the surface of carbon black is readily damaged, thereby affecting the dispersibility of the carbon black. As a result, the issue of reduced surface resistance of the black matrix can readily occur.

### Other Alkai-Soluble Resins (A-2)

The alkali-soluble resin (A) can further optionally include other alkai-soluble resins (A-2). The other alkali-soluble resins (A-2) are, for instance, resins having a carboxylic acid group or a hydroxyl group. Specific examples of the other alkai-soluble resins (A-2) include resins other than the resin (A-1) having an unsaturated group such as acrylic-based resin, urethane-based resin, or novolac resin.

Based on a usage amount of 100 parts by weight of the alkai-soluble resin (A), the usage amount of the other alkali-soluble resins (A-2) is 0 parts by weight to 70 parts by weight, preferably 0 parts by weight to 50 parts by weight, and more preferably 0 parts by weight to 30 parts by weight.

### Compound (B) Having an Ethylenically Unsaturated Group

The compound (B) having an ethylenically unsaturated group can be selected from a compound (B-1) having one ethylenically unsaturated group or a compound (B-2) having at least two (including two) ethylenically unsaturated groups.

Specific examples of the compound (B-1) having one ethylenically unsaturated group include, for instance, (meth)acrylamide, (meth)acryloylmorpholine, 7-amino-3,7-dimethyloctyl(meth)acrylate, isobutoxymethyl(meth)acrylamide, isobornyloxyethyl(meth)acrylate, isobornyl(meth)acrylate, 2-ethylhexyl(meth)acrylate, ethyl diethylene glycol(meth)acrylate, t-octyl(meth)acrylamide, diacetone(meth)acrylamide, dimethylaminoethyl(meth)acrylate, dodecyl(meth)acrylate, dicyclopentenyloxyethyl(meth)acrylate, dicyclopentenyl(meth)acrylate, N,N-dimethyl(meth)acrylamide, tetrachlorophenyl(meth)acrylate, 2-tetrachlorophenoxy ethyl(meth)acrylate, tetrahydrofurfuryl(meth)acrylate, tetrabromophenyl(meth)acrylate, 2-tetrabromophenoxyethyl(meth)acrylate, 2-trichlorophenoxyethyl(meth)acrylate, tribromophenyl(meth)acrylate, 2-tribromophenoxyethyl(meth)acrylate, 2-hydroxyethyl(meth)acrylate, 2-hydroxypropyl(meth)acrylate, vinylcaprolactam, N-vinylpyrrolidone, phenoxyethyl(meth)acrylate, pentachlorophenyl(meth)acrylate, pentabromophenyl(meth)acrylate, polyethylene glycol mono(meth)acrylate, polypropylene glycol mono(meth)acrylate, or bornyl(meth)acrylate. The compound (B-1) having 1 ethylenically unsaturated group can be used alone or in multiple combinations.

Specific examples of the compound (B-2) having at least two (including two) ethylenically unsaturated groups include ethylene glycol di(meth)acrylate, dicyclopentenyl di(meth)acrylate, triethylene glycol di(meth)acrylate, tetraethylene glycol di(meth)acrylate, tri(2-hydroxyethyl)isocyanate di(meth)acrylate, tri(2-hydroxyethyl)isocyanate tri(meth)acrylate, caprolactone-modified tri(2-hydroxyethyl)isocyanate tri(meth)acrylate, trimethylolpropyl tri(meth)acrylate, ethylene oxide (EO) modified trimethylolpropyl tri(meth)acrylate, propylene oxide (PO) modified trimethylolpropyl tri(meth)acrylate, tripropylene glycol di(meth)acrylate, neo-pentyl glycol di(meth)acrylate, 1,4-butanediol di(meth)acrylate, 1,6-hexanediol di(meth)acrylate, pentaerythritol tri(meth)acrylate, pentaerythritol tetra(meth)acrylate, polyester di(meth)acrylate, polyethylene glycol di(meth)acrylate, dipentaerythritol hexa(meth)acrylate, dipentaerythritol penta(meth)acrylate, dipentaerythritol tetra(meth)acrylate, caprolactone-modified dipentaerythritol hexa(meth)acrylate, caprolactone-modified dipentaerythritol penta(meth)acrylate, di(trimethylolpropyl) tetra(meth)acrylate, EO-modified bisphenol A di(meth)acrylate, PO-modified bisphenol A di(meth)acrylate, EO-modified hydrogenated bisphenol A di(meth)acrylate, PO-modified hydrogenated bisphenol A di(meth)acrylate, PO-modified glycerol tri(meth)acrylate, EO-modified bisphenol F di(meth)acrylate, polyglycidyl(meth)acrylate of novolac resin, or a similar compound thereof, or a combination of the compounds. The compound (B-2) having at least two (including two) ethylenically unsaturated groups can be used alone or in multiple combinations.

Specific examples of the compound (B) having an ethylenically unsaturated group include trimethylolpropyl triacrylate, EO-modified trimethylolpropyl triacrylate, PO-modified trimethylolpropyl triacrylate, pentaerythritol triacrylate, pentaerythritol tetraacrylate, dipentaerythritol hexaacrylate, dipentaerythritol pentaacrylate, dipentaerythritol tetraacrylate, caprolactone-modified dipentaerythritol hexaacrylate, di(trimethylolpropyl) tetraacrylate, PO-modified glycerol triacrylate, or a similar compound thereof, or a combination of the compounds.

The compound (B) having an ethylenically unsaturated group is preferably trimethylolpropyl triacrylate, dipentaerythritol tetracrylate, dipentaerythritol hexaacrylate, or a combination of the compounds.

Based on a usage amount of 100 parts by weight of the alkali-soluble resin (A), the usage amount of the compound (B) having an ethylenically unsaturated group is 15 parts by weight to 180 parts by weight, preferably 20 parts by weight to 150 parts by weight, and more preferably 25 parts by weight to 120 parts by weight.

### Photoinitiator (C)

The photoinitiator (C), for instance, produces a substance having a free radical through irradiation. Moreover, the substance having a free radical can initiate a cross-linking reaction between polymers, between a polymer and an oligomer, and between a polymer and a monomer, thereby forming a hardened layer (such as a black matrix) having good mechanical strength.

Specific examples of the photoinitiator (C) include an O-acyloxime compound, a triazine compound, a acetophenone compound, a diimidazole compound, a benzophenone compound, an u-diketone compound, a ketol compound, an acyloin ether compound, an acylphosphine oxide compound, a quinone compound, a halogen-containing compound, peroxide, or a combination of the compounds.

Specific examples of the O-oxime compound include 1-[4-(phenylthio)phenyl]-heptane-1,2-dione 2-(O-benzoyloxime), 1-[4-(phenylthio)phenyl]-octane-1,2-dione 2-(O-benzoyloxime), 1-[4-(benzoyl)phenyl]-heptane-1,2-dione 2-(O-benzoyloxime), 1-[9-ethyl-6-(2-methylbenzoyl)-9H-carbazol-3-yl]-ethanone 1-(O-acetyloxime), 1-[9-ethyl-6-(3-methylbenzoyl)-9H-carbazol-3-yl]-ethanone 1-(O-acetyloxime), 1-[9-ethyl-6-benzoyl-9H-carbazol-3-yl]-ethanone 1-(O-acetyloxime), ethanone-1-[9-ethyl-6-(2-methyl-4-(tetrahydrofuranyl)benzoyl)-9H-carbazol-3-yl]-1-(O-acetyloxime), ethanone-1-[9-ethyl-6-(2-methyl-4-(tetrahydropyranyl)benzoyl)-9H-carbazol-3-yl]-1-(O-acetyloxime), ethanone-1-[9-ethyl-6-(2-methyl-5-(tetrahydrofuranyl)benzoyl)-9H-carbazol-3-yl]-1-(O-acetyloxime), ethanone-1-[9-ethyl-6-(2-methyl-5-(tetrahydropyranyl)benzoyl)-9H-carbazol-3-yl]-1-(O-acetyloxime), ethanone-1-[9-ethyl-6-(2-methyl-4-(tetrahydrofuranyl)methoxybenzoyl)-9H-carbazol-3-yl]-1-(O-acetyloxime), ethanone-1-[9-ethyl-6-(2-methyl-4-(tetrahydropyranyl)methoxybenzoyl)-9H-carbazol-3-yl]-1-(O-acetyloxime), ethanone-1-[9-ethyl-6-(2-methyl-5-(tetrahydrofuranyl)methoxybenzoyl)-9H-carbazol-3-yl]-1-(O-acetyloxime), ethanone-1-[9-ethyl-6-(2-methyl-5-(tetrahydropyranyl)methoxybenzoyl)-9H-carbazol-3-yl]-1-(O-acetyloxime), ethanone-1-[9-ethyl-6-{2-methyl-4-(2,2-dimethyl-1,3-dioxacyclopentyl)benzoyl}-9H-carbazol-3-yl]-1-(O-acetyloxime), ethanone-1-[9-ethyl-6-{2-methyl-4-(2,2-dimethyl-1,3-dioxacyclopentyl)methoxybenzoyl}-9H-carbazol-3-yl]-1-(O-acetyloxime), or a similar compound thereof, or a combination of the compounds.

The O-oxime compound is preferably 1-[4-(phenylthio)phenyl]-octane-1,2-dione-2-(O-benzoyloxime) (product name: OXE-01, made by Ciba Specialty Chemicals Co., Ltd.), 1-[9-ethyl-6-(2-methylbenzoyl)-9H-carbazol-3-yl]-ethanone 1-(O-acetyloxime) (product name: OXE-02, made by Ciba Specialty Chemicals Co., Ltd.), ethanone-1-[9-ethyl-6-(2-methyl-4-(tetrahydrofuranyl)methoxybenzoyl)-9H-carbazol-3-yl]-1-(O-acetyloxime), ethanone-1-[9-ethyl-6-{2-methyl-4-(2,2-dimethyl-1,3-dioxacyclopentyl)methoxybenzoyl}-9H-carbazol-3-yl]-1-(O-acetyloxime), or a combination of the compounds. The O-oxime compound can be used alone or in multiple combinations.

Specific examples of the triazine compound include a vinyl halomethyl-s-triazine compound, a 2-(naphtho-1-yl)-4,6-dihalomethyl-s-triazine compound, a 4-(p-aminophenyl)-2,6-dihalomethyl-s-triazine compound, or a similar compound thereof, or a combination of the compounds.

Specific examples of the vinyl halomethyl-s-triazine compound include 2,4-bis(trichloromethyl)-6-p-methoxystyryl-s-triazine, 2,4-bis(trichloromethyl)-3-(1-p-dimethylaminophenyl-1,3-butadienyl)-s-triazine, 2-trichloromethyl-3-amino-6-p-methoxystyryl-s-triazine, or a similar compound thereof, or a combination of the compounds.

Specific examples of the 2-(naphtho-1-yl)-4,6-dihalomethyl-s-triazine compound include 2-(naphtho-1-yl)-4,6-bis-trichloromethyl-s-triazine, 2-(4-methoxy-naphtho-1-yl)-4,6-bis-trichloromethyl-s-triazine, 2-(4-ethoxy-naphtho-1-yl)-4,6-bis-trichloromethyl-s-triazine, 2-(4-butoxy-naphtho-1-yl)-4,6-bis-trichloromethyl-s-triazine, 2-(4-(2-methoxyethyl)-naphtho-1-yl)-4,6-bis-trichloromethyl-s-triazine, 2-(4-(2-ethoxyethyl)-naphtho-1-yl)-4,6-bis-trichloromethyl-s-triazine, 2-(4-(2-butoxyethyl)-naphtho-1-yl)-4,6-bis-trichloromethyl-s-triazine, 2-(2-methoxy-naphtho-1-yl)-4,6-bis-trichloromethyl-s-triazine, 2-(6-methoxy-5-methyl-naphtho-2-yl)-4,6-bis-trichloromethyl-s-triazine, 2-(6-methoxynaphtho-2-yl)-4,6-bis-trichloromethyl-s-triazine, 2-(5-methoxy-naphtho-1-yl)-4,6-bis-trichloromethyl-s-triazine, 2-(4,7-dimethoxy-naphtho-1-yl)-4,6-bis-trichloromethyl-s-triazine, 2-(6-ethoxy-naphtho-2-yl)-4,6-bis-trichloromethyl-s-triazine, 2-(4,5-dimethoxy-naphtho-1-yl)-4,6-bis-trichloromethyl-s-triazine, or a similar compound thereof, or a combination of the compounds.

Specific examples of the 4-(p-aminophenyl)-2,6-dihalomethyl-s-triazine compound include 4-(p-N,N-di(ethoxycarbonylmethyl)aminophenyl)-2,6-di(trichloromethyl)-s-triazine, 4-(o-methyl-p-N,N-di(ethoxycarbonylmethyl)aminophenyl)-2,6-di(trichloromethyl)-s-triazine, 4-(p-N,N-di(chloroethyl)aminophenyl)-2,6-di(trichloromethyl)-s-triazine, 4-(o-methyl-p-N,N-di(chloroethyl)aminophenyl)-2,6-di(trichloromethyl)-s-triazine, 4-(p-N-chloroethylaminophenyl)-2,6-di(trichloromethyl)-s-triazine, 4-(p-N-ethoxycarbonylmethylaminophenyl)-2,6-di(trichloromethyl)-s-triazine, 4-(p-N,N-di(phenyl)aminophenyl)-2,6-di(trichloromethyl)-s-triazine, 4-(p-N-chloroethylcarbonylaminophenyl)-2,6-di(trichloromethyl)-s-triazine, 4-(p-N-(p-methoxyphenyl)carbonylaminophenyl)-2,6-di(trichloromethyl)-s-triazine, 4-(m-N,N-di(ethoxycarbonylmethyl)aminophenyl)-2,6-di(trichloromethyl)-s-triazine, 4-(m-bromo-p-N,N-di(ethoxycarbonylmethyl) aminophenyl)-2,6-di(trichloromethyl)-s-triazine, 4-(m-chloro-p-N,N-di(ethoxycarbonylmethyl)aminophenyl)-2,6-di(trichloromethyl)-s-triazine, 4-(m-fluoro-p-N,N-di(ethoxycarbonylmethyl)aminophenyl)-2,6-di(trichloromethyl)-s-triazine, 4-(o-bromo-p-N,N-di(ethoxycarbonylmethyl)aminophenyl)-2,6-di(trichloromethyl)-s-triazine, 4-(o-chloro-p-N,N-di(ethoxycarbonylmethyl)aminophenyl)-2,6-di(trichloromethyl)-s-triazine, 4-(o-fluoro-p-N,N-di(ethoxycarbonylmethyl)aminophenyl)-2,6-di(trichloromethyl)-s-triazine, 4-(o-bromo-p-N,N-di(chloroethyl)aminophenyl)-2,6-di(trichloromethyl)-s-triazine, 4-(o-chloro-p-N,N-di(chloroethyl)aminophenyl)-2,6-di(trichloromethyl)-s-triazine, 4-(o-fluoro-p-N,N-di(chloroethyl)aminophenyl)-2,6-di(trichloromethyl)-s-triazine, 4-(m-bromo-p-N,N-di(chloroethyl)aminophenyl)-2,6-di(trichloromethyl)-s-triazine, 4-(m-chloro-p-N,N-di(chloroethyl)aminophenyl)-2,6-di(trichloromethyl)-s-triazine, 4-(m-fluoro-p-N,N-di(chloroethyl)aminophenyl)-2,6-di(trichloromethyl)-s-triazine, 4-(m-bromo-p-N-ethoxycarbonylmethylaminophenyl)-2,6-di(trichloromethyl)-s-triazine, 4-(m-chloro-p-N-ethoxycarbonylmethylaminophenyl)-2,6-di(trichloromethyl)-s-triazine, 4-(m-fluoro-p-N-ethoxycarbonylmethylaminophenyl)-2,6-di(trichloromethyl)-s-triazine, 4-(o-bromo-p-N-ethoxycarbonylmethylaminophenyl)-2,6-di(trichloromethyl)-s-triazine, 4-(o-chloro-p-N-ethoxycarbonylmethylaminophenyl)-2,6-di(trichloromethyl)-s-triazine, 4-(o-fluoro-p-N-ethoxycarbonylmethylaminophenyl)-2,6-di(trichloromethyl)-s-triazine, 4-(m-bromo-p-N-chloroethylaminophenyl)-2,6-di(trichloromethyl)-s-triazine, 4-(m-chloro-p-N-chloroethylaminophenyl)-2,6-di(trichloromethyl)-s-triazine, 4-(m-fluoro-p-N-chloroethylaminophenyl)-2,6-di(trichloromethyl)-s-triazine, 4-(o-bromo-p-N-chloroethylaminophenyl)-2,6-di(trichloromethyl)-s-triazine, 4-(o-chloro-p-N-chloroethylaminophenyl)-2,6-di(trichloromethyl)-s-triazine, 4-(o-fluoro-p-N-chloroethylaminophenyl)-2,6-di(trichloromethyl)-s-triazine, 2,4-di(trichloromethyl)-6-(3-bromo-4-(N,N-di(ethoxycarbonylmethyl)amino)phenyl)-1,3,5-triazine, or a similar compound thereof, or a combination of the compounds.

The triazine compound is preferably 4-(m-bromo-p-N,N-di(ethoxycarbonylmethyl)aminophenyl)-2,6-di(trichloromethyl)-s-triazine, 2,4-di(trichloromethyl)-6-p-methoxystyryl-s-triazine, or a combination of the compounds. The triazine compound can be used alone or in multiple combinations.

Specific examples of the acetophenone compound include p-dimethylamino-acetophenone, α,α′-dimethoxyazoxy-acetophenone, 2,2′-dimethyl-2-phenyl-acetophenone, p-methoxy-acetophenone, 2-benzyl-2-N,N-dimethylamino-1-(4-morpholinophenyl)-1-butanone, 2-methyl-1-(4-methylthio phenyl)-2-morpholino-1-propanone, or a similar compound thereof, or a combination of the compounds. The acetophenone compound is preferably 2-methyl-1-(4-methylthio)phenyl-2-morpholinyl-1-propanone or 2-benzyl-2-N,N-dimethylamino-1-(4-morpholino phenyl)-1-butanone. The acetophenone compound can be used alone or in multiple combinations.

Specific examples of the diimidazole compound include 2,2′-bis(o-chlorophenyl)-4,4′,5,5′-tetraphenyldiimidazole, 2,2′-bis(o-fluorophenyl)-4,4′,5,5′-tetraphenyldiimidazole, 2,2′-bis(o-methylphenyl)-4,4′,5,5′-tetraphenyldiimidazole, 2,2′-bis(o-methoxyphenyl)-4,4′,5,5′-tetraphenyldiimidazole, 2,2′-bis(o-ethylphenyl)-4,4′,5,5′-tetraphenyldiimidazole, 2,2′-bis(p-methoxyphenyl)-4,4′,5,5′-tetraphenyldiimidazole, 2,2′-bis(2,2′,4,4′-tetramethoxyphenyl)-4,4′,5,5′-tetraphenyldiimidazole, 2,2′-bis(2-chlorophenyl)-4,4′,5,5′-tetraphenyldiimidazole, 2,2′-bis(2,4-dichlorophenyl)-4,4′,5,5′-tetraphenyldiimidazole, or a similar compound thereof, or a combination of the compounds. The diimidazole compound is preferably 2,2′-bis(2,4-dichlorophenyl)-4,4′,5,5′-tetraphenyldiimidazole. The diimidazole compound can be used alone or in multiple combinations.

Specific examples of the benzophenone compound include thioxanthone, 2,4-diethylthioxanthone, thioxanthone-4-sulfone, benzophenone, 4,4′-bis(dimethylamino)benzophenone, 4,4′-bis(diethylamino)benzophenone, or a similar compound thereof, or a combination of the compounds. The benzophenone compound is preferably 4,4′-bis(diethylamino)benzophenone. The benzophenone compound can be used alone or in multiple combinations.

Specific examples of the α-diketone compounds include, for instance, diphenyl-ethanedione or a compound having acetyl group. Specific examples of the acyloin ether compound include benzoin. Specific examples of the acyloin ether compound include benzoin methyl ether, benzoin ethyl ether, benzoin isopropyl ether, or a similar compound thereof, or a combination of the compounds. Specific examples of the acylphosphine oxide compound include (2,4,6-trimethylbenzoyl)diphenylphosphine oxide, bis(2,6-dimethoxybenzoyl)-2,4,4-trimethylpentylphosphine oxide, or a similar compound thereof, or a combination of the compounds. Specific examples of the quinone compound include anthraquinone, 1,4-naphthoquinone, or a similar compound thereof, or a combination of the compounds. Specific examples of the halogen-containing compound include phenacyl chloride, tribromomethyl phenyl sulfone, tris(trichloromethyl)-s-triazine, or a similar compound thereof, or a combination of the compounds. Specific examples of the peroxide include, for instance, di-tert-butyl peroxide. The α-diketone compound, ketol compound, ether ketone compound, acylphosphine oxide compound, quinone compound, halogen-containing compound, or a similar compound thereof can be used alone or in combination.

The photoinitiator (C) is preferably 1-[9-ethyl-6-(2-methylbenzoyl)-9H-carbazol-3-yl]-ethanone 1-(O-acetyloxime) (product name: OXE-02, made by Ciba Specialty Chemicals Co., Ltd.), 1-[4-(phenylthio)phenyl]-octane-1,2-dione 2-(O-benzoyloxime) (product name: OXE-01, made by Ciba Specialty Chemicals Co., Ltd.), 2-methyl-1-[4-(methylthio)phenyl]-2-morpholino-1-propanone (product name: IRGACURE 907, made by Ciba Specialty Chemicals Co., Ltd.), or a combination of the compounds.

Based on a usage amount of 100 parts by weight of the alkali-soluble resin (A), the usage amount of the photoinitiator (C) is 5 to 60 parts by weight, preferably 7 to 55 parts by weight, and more preferably 10 to 50 parts by weight.

### Solvent (D)

The solvent (D) refers to a solvent that can dissolve the alkali-soluble resin (A), the compound (B) having an ethylenically unsaturated group, the photoinitiator (C), and the cross-linking agent (F) but does not react with the components, the black pigment (E), and the inorganic particle (G). Moreover, the solvent (D) preferably has a suitable volatility.

Specific examples of the solvent (D) include an alkylene glycol monoalkyl ether compound, an alkylene glycol monoalkyl ether acetate compound, diethylene glycol alkyl ether, other ether compounds, a ketone compound, a lactic acid alkyl ester compound, other ester compounds, an aromatic hydrocarbon compound, a carboxylic acid amine compound, or a combination of the compounds.

Specific examples of the alkyl glycol monoalkyl ether compound include ethylene glycol monomethyl ether, ethylene glycol monoethyl ether, diethylene glycol monoethyl ether, diethylene glycol mono-n-propyl ether, diethylene glycol mono-n-butyl ether, triethylene glycol monomethyl ether, triethylene glycol monoethyl ether, propylene glycol monomethyl ether, propylene glycol monoethyl ether, dipropylene glycol monomethyl ether, dipropylene glycol monoethyl ether, dipropylene glycol mono-n-propyl ether, dipropylene glycol monon-butyl ether, tripropylene glycol monomethyl ether, tripropylene glycol monoethyl ether, or a similar compound thereof, or a combination of the compounds.

Specific examples of the alkyl glycol monoalkyl ether acetate compound include ethylene glycol monomethyl ether acetate, ethylene glycol monoethyl ether acetate, propylene glycol monomethyl ether acetate, propylene glycol monoethyl ether acetate, or a similar compound thereof, or a combination of the compounds.

Specific examples of the diethylene glycol alkyl ether include diethylene glycol dimethyl ether, diethylene glycol ethyl methyl ether, diethylene glycol diethyl ether, or a similar compound thereof, or a combination of the compounds.

Specific examples of the other ether compounds include tetrahydrofuran or a similar compound thereof.

Specific examples of the ketone compound include methyl ethyl ketone, cyclohexanone, 2-heptanone, 3-heptanone, diacetone alcohol, or a similar compound thereof, or a combination of the compounds.

Specific examples of the lactic acid alkyl ester compound include methyl lactate, ethyl lactate, or a similar compound thereof, or a combination of the compounds.

Specific examples of the other ester compounds include methyl 2-hydroxy-2-methylpropanoate, ethyl 2-hydroxy-2-methylpropanoate, methyl 3-methoxypropanoate, ethyl 3-methoxypropanoate, methyl 3-ethoxypropanoate, ethyl 3-ethoxypropanoate, ethyl ethoxyacetate, ethyl hydroxyacetate, methyl 2-hydroxy-3-methylbutyrate, 3-methyl-3-methoxybutyl acetate, 3-methyl-3-methoxybutyl propanoate, ethyl acetate, n-propyl acetate, isopropyl acetate, n-butyl acetate, isobutyl acetate, n-amyl acetate, isoamyl acetate, n-butyl propanoate, ethyl butyrate, n-propyl butyrate, isopropyl butyrate, n-butyl butyrate, methyl pyruvate, ethyl pyruvate, n-propyl pyruvate, methyl acetoacetate, ethyl acetoacetate, ethyl 2-oxybutyrate, or a similar compound thereof, or a combination of the compounds.

Specific examples of the aromatic hydrocarbon compound include toluene, xylene, or a similar compound thereof, or a combination of the compounds.

Specific examples of the carboxylic acid amine compound include N-methylpyrrolidone, N,N-dimethyl formamide, N,N-dimethyl acetamide, or a similar compound thereof, or a combination of the compounds. The solvent (D) can be used alone or in multiple combinations.

The solvent (D) is preferably propylene glycol monomethyl ether acetate or ethyl 3-ethoxypropionate.

Based on a usage amount of 100 parts by weight of the alkali-soluble resin (A), the usage amount of the solvent (D) is 1,000 parts by weight to 5,000 parts by weight, preferably 1,200 parts by weight to 4,500 parts by weight, and more preferably 1,500 parts by weight to 4,000 parts by weight.

### Black Pigment (F)

The black pigment (F) is preferably a black pigment having heat resistance, light resistance, and solvent resistance.

Specific examples of the black pigment (F) include organic black organic pigments such as perylene black, cyanine black, or aniline black; a near-black mixture of organic pigments obtained by mixing two or more pigments selected from the pigments of, for instance, red, blue, green, purple, yellow, cyanine, or magenta; light-shielding materials such as carbon black, chromium oxide, ferric oxide, titanium black, or graphite, wherein specific examples of the carbon black include C.I. pigment black 7 or commercial products made by Mitsubishi Chemical Corporation (product names MA100, MA230, MA8, #970, #1000, #2350, or #2650). The black pigment (F) can be used alone or in multiple combinations.

The black pigment (F) is preferably carbon black, and the carbon black is, for instance, the commercial product MA100 or MA230 made by Mitsubishi Chemical Corporation.

Based on a usage amount of 100 parts by weight of the alkali-soluble resin (A), the usage amount of the black pigment (F) is 100 parts by weight to 800 parts by weight, preferably 120 parts by weight to 700 parts by weight, and more preferably 150 parts by weight to 600 parts by weight.

### Cross-Linking Agent (f)

The cross-linking agent (F) is a compound facilitating covalent bonding or ionic bonding between linear molecules to make linear molecules bond to one another, thereby forming a polymer network. It should be mentioned that, the alkali-soluble resin (A) can react with the cross-linking agent (F) at high temperature to form a polymer having a higher degree of cross-linking.

The cross-linking agent (F) includes a cross-linking agent (F-1), and the cross-linking agent (F-1) is obtained by reacting a novolac resin represented by formula (f-1) and epihalohydrin under an existence of an alkali metal hydroxide. Moreover, the cross-linking agent (F) can further include other cross-linking agents (F-2). The cross-linking agent (F-1) and the other cross-linking agents (F-2) are described in detail below.

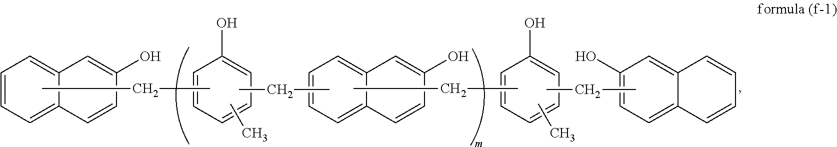

in formula (f-1), m represents an integer of 0 to 7.

### Cross-Linking Agent (F-1)

The novolac resin represented by formula (f-1) is obtained by polymerizing a product and cresol under an existence of an acid catalyst, wherein the product is formed by reacting β-naphthol and the source substance of formaldehyde. The softening temperature of the novolac resin represented by formula (f-1) is 100° C. to 110° C.

The source substance of formaldehyde is, for instance, a material capable of producing formaldehyde under an alkaline condition. Specifically, the source substance of formaldehyde includes paraformaldehyde, trioxane, tetraoxane, or a similar compound thereof.

The reaction conditions of β-naphthol and the source substance of formaldehyde are as follows: with a ratio of a usage amount of 0.9 moles to 1.3 moles (based on the amount of formaldehyde) of the source substance of formaldehyde based on 1 mole of the β-naphthol, β-naphthol and the source substance of formaldehyde are reacted under an alkaline condition at a temperature of 5° C. to 40° C. for 5 minutes to 5 hours. The reaction is generally performed under an existence of an alkali catalyst. Specific examples of the alkali catalyst include sodium hydroxide, potassium hydroxide, sodium carbonate, potassium carbonate, or a similar compound thereof. The alkali catalyst is preferably sodium hydroxide. Based on 1 mole of the β-naphthol, the usage amount of the alkali catalyst is 0.02 equivalents to 1.5 equivalents. Moreover, the reaction can be performed under an existence of a solvent, wherein specific examples of the solvent include toluene, xylene, or methyl isobutyl ketone. Based on a total weight of 100 wt % of the components of the reaction, the usage amount of the solvent is 30 wt % to 300 wt %. After the reaction is complete, an acidic substance such as hydrochloric acid or sulfuric acid can be used as a neutralizer. Specifically, a liquid separation extract operation is performed by using an aqueous solution containing a neutralizer to rinse the reaction mixture to obtain a cleaning solution of the reaction mixture. Moreover, the cleaning solution is rinsed repeatedly until the pH value of the cleaning solution is 4 to 7, preferably 5 to 7. Furthermore, the solvent can be removed by distillation when needed.

The resulting product (hereinafter naphthol methylol body) of β-naphthol and the source substance of formaldehyde is preferably β-naphthol monomethylol body, and more preferably 1-methylol-2-naphthol. Then, under an existence of an acid catalyst, naphthol methylol body and cresol are reacted in a condensation reaction to obtain the novolac resin represented by formula (f-1). The cresol is, for instance, o-cresol, m-cresol, or p-cresol, wherein the cresol is preferably o-cresol or p-cresol. Moreover, the reaction temperature is generally 5° C. to 180° C. and preferably 30° C. to 130° C. The reaction time is generally 1 to 30 hours and preferably 2 to 25 hours. Moreover, the water formed in the reaction can be removed with a fractionating column to speed up the reaction. Based on 1 mole of the naphthol methylol body, the usage amount of cresol is generally 0.4 moles to 1.1 moles and preferably 0.5 moles to 1.0 mole.

In the novolac resin, a by-product (i.e., dimer of β-naphthol) of the reaction may exist, and the by-product deteriorates the heat resistance of the cured product. Therefore, after the condensation reaction, to remove the by-product, an acid catalyst can be added when needed, and the temperature of the reaction system is preferably raised to 60° C. to 130° C. Regarding the mechanism, the dimer of β-naphthol is presumably rearranged (such as dissociation of the dimer of β-naphthol or the reaction with a cresol compound) in the post-reaction.

Specific examples of the acid catalyst of the condensation reaction are preferably organic or inorganic acids such as hydrochloric acid, sulfuric acid, p-toluenesulfonic acid, or oxalic acid; or lewis acids such as boron trifluoride, anhydrous aluminium chloride, or lead dichloride, and more preferably p-toluenesulfonic acid, sulfuric acid, or hydrochloric acid. The usage amount of the acid catalyst is not particularly limited. However, based on 100 parts by weight of the naphthol methylol, the acid catalyst is generally 0.05 parts by weight to 50 parts by weight and preferably 0.1 parts by weight to 20 parts by weight.

The condensation reaction can be performed without a solvent or under an existence of a solvent. Specific examples of the solvent include, for instance, toluene, xylene, methyl isobutyl ketone, or water. The solvent can be used alone or in multiple combinations of two or more. Based on a total weight of the components of the reaction, the usage amount of the solvent is 50 wt % to 300 wt % and preferably 100 wt % to 250 wt %.

After the reaction is complete, a rinse treatment is performed repeatedly to the reaction mixture until the pH value of the cleaning solution is 3 to 7, and the pH value of the cleaning solution is preferably 5 to 7. The rinse treatment preferably uses various alkaline substances as a neutralizer. Specific examples of the neutralizer include alkali metal hydroxides such as sodium hydroxide or potassium hydroxide; alkaline earth metal hydroxides such as calcium hydroxide or magnesium hydroxide; ammonia; sodium dihydrogenphosphate; or organic amines such as diethylenetriamine, triethylenetetramine, aniline, or phenylenediamine. The rinse treatment can be performed with a known method. Moreover, in the rinse treatment, for instance, water with the neutralizer dissolved therein is added in the reaction mixture and the liquid separation extract operation is performed repeatedly.

After the neutralization and the rinse treatment, unreacted naphthol methylol body and solvent are fractionated by heating under reduced pressure to obtain the product. In this way, the novolac resin represented by formula (f-1) can be obtained.

The softening temperature of the obtained novolac resin represented by formula (f-1) is generally 95° C. to 115° C., preferably 100° C. to 110° C. Moreover, the melt viscosity at 150° C. is 0.5 poise to 2.5 poise and preferably 1.0 poise to 2.0 poise.

Specific examples of the cross-linking agent (F-1) include ESN-175 and ESN-375 made by Nippon Steel Chemical Co., Ltd. or NC-7300L made by Nippon Kayaku Co., Ltd.

Moreover, based on 100 parts by weight of the alkali-soluble resin (A), the usage amount of the cross-linking agent (F-1) is 2 parts by weight to 20 parts by weight, preferably 3 parts by weight to 15 parts by weight, and more preferably 4 parts by weight to 10 parts by weight.

It should be mentioned that, since the cross-linking agent (F-1) obtained by reacting epihalohydrin and the novolac resin represented by formula (f-1) can effectively strengthening the degree of cross-linking of the polymer in the cured product (i.e., black matrix), the heat resistance of the cured product (i.e., black matrix) is also increased. As a result, the polymer of carbon black after surface modification is not readily damaged, and the carbon black can maintain good dispersibility. Therefore, if the photosensitive resin composition for a black matrix does not contain the cross-linking agent (F-1), then the issue of reduced surface resistance readily occurs to the black matrix.

### Other Cross-Linking Agents (F-2)

The other cross-linking agents (F-2) include compounds having an epoxy group other than the cross-linking agent (F-1). Specifically, the cross-linking agents (F-2) include (poly)glycidyl ether, (poly)glycidyl ester, (poly)glycidyl amine, other compounds having an epoxy group, or a combination of the compounds.

The (poly)glycidyl ether is obtained by reacting a monohydroxy compound or a polyhydroxy compound with epichlorohydrin. Specific examples of the (poly)glycidyl ether include glycidyl ether resins such as a diglycidyl ether type epoxy resin of polyethylene glycol, a diglycidyl ether-type epoxy resin of bis(4-hydroxyphenyl), a diglycidyl ether-type epoxy resin of bis(3,5-dimethyl-4-hydroxyphenyl), a diglycidyl ether-type epoxy resin of bisphenol F, a diglycidyl ether-type epoxy resin of bisphenol A, a diglycidyl ether-type epoxy resin of tetramethyl bisphenol A, a diglycidyl ether-type epoxy resin of bisphenol A ethylene oxide adduct, a dihydroxylfluorene-type epoxy resin, a dihydroxyl alkyleneoxyl fluorene-type epoxy resin, a bisphenol A/aldehyde novolac-type epoxy resin, a phenol novolac-type epoxy resin, or a cresol novolac-type epoxy resin; or a bisphenol S epoxy resin, a phenol novolac epoxy resin, a cresol novolac epoxy resin, a tris-phenol epoxy resin, or an epoxy resin polymerized from dicyclopentadiene and phenol. The (poly)glycidyl ether can be used alone or in multiple combinations. In the (poly)glycidyl ether, the carboxyl group is preferably introduced by reacting the remaining hydroxyl groups with an anhydride or a divalent carboxylic acid compound.

The (poly)glycidyl ester is obtained by reacting a (poly)carboxylic acid compound with epichlorohydrin. Specific examples of the (poly)glycidyl ester include diglycidyl ester type epoxy resins of a hexahydrophthalic acid, diglycidyl ester type epoxy resins of a phthalic acid, or a combination of the compounds. The (poly)glycidyl ester can be used alone or in multiple combinations.

The (poly)glycidyl amine is obtained by reacting a (poly)amine compound with epichlorohydrin. Specific examples of the (poly)glycidyl amine include diglycidyl amine type epoxy resins of bis(4-aminophenyl)methane, triglycidyl amine type epoxy resins of isocyanuric acid, or a combination of the compounds. The (poly)glycidyl amine can be used alone or in multiple combinations.

The other compounds having an epoxy group are, for instance, obtained by reacting a single or a plurality of (meth)acrylates having an epoxy group with other comonomers. Specific examples of the (meth)acrylate having an epoxy group include glycidyl (meth)acrylate, α-ethyl glycidyl acrylate, α-n-propyl glycidyl acrylate, α-n-butyl glycidyl acrylate, 3,4-epoxybutyl(meth)acrylate, 4,5-epoxypentyl(meth)acrylate, 6,7-epoxyheptyl(meth)acrylate, or α-ethyl 6,7-epoxyhepty acrylate. The (meth)acrylate having an epoxy group can be used alone or in multiple combinations. The (meth)acrylate having an epoxy group is preferably glycidyl(meth)acrylate.

Specific examples of the other comonomers include (meth)acrylic acid; (meth)acrylates such as methyl(meth)acrylate, ethyl(meth)acrylate, butyl(meth)acrylate, methyl(meth)acrylate, 2-ethylhexyl(meth)acrylate, phenyl(meth)acrylate, cyclohexyl(meth)acrylate, dicyclopentanyl(meth)acrylate, dicyclopentyl ethoxy(meth)acrylate, or isobornyl(meth)acrylate; or vinyl aromatic compounds such as styrene, α-methylstyrene, p-methylstyrene, or naphthalene. The other comonomers can be used alone or in multiple combinations. The other comonomers are preferably dicyclopentyl(meth)acrylate, α-styrene, or a combination of the compounds.

Based on the total amount of the structural unit of the (meth)acrylate having an epoxy group and the other comonomers, the usage amount of the structural unit of the (meth)acrylate having an epoxy group is generally 10 mol % to 70 mol % and preferably 15 mol % to 60 mol %.

Specific examples of the other cross-linking agents (F-2) include ECN1273 (made by Ciba Specialty Chemicals Co., Ltd.), Epikote 157S70 (made by Yuka Shell Epoxy Co., Ltd.), Epikote 1032H60 (made by Yuka Shell Epoxy Co., Ltd.), Epikote 180S65 (made by Japan Epoxy Resins Co. Ltd), Epichlone N-600 series (made by DIC Corporation), or TACTIX742 (made by Ciba-Geigy Ltd.).

Based on 100 parts by weight of the alkali-soluble resin (A), the usage amount of the cross-linking agent (F) is 2 to 30 parts by weight, preferably 4 to 25 parts by weight, and more preferably 4 to 20 parts by weight.

### Inorganic Particle (G)

The inorganic particle (G) employs oxides of a Group 4 element, oxides of silicone, or a combination of the two to serve as the major component, wherein the Group 4 element is, for instance, titanium (Ti), zirconium (Zr), or hafnium (Hf).

In the inorganic particle (G), specific examples of the oxide particles of a Group 4 element include titanium oxide, zirconium oxide, hafnium oxide, or composite particles of the metal oxides, silicon dioxide, or tin oxide.

Moreover, the inorganic particle (G) can be in powder form or dispersol form of dispersed oxide particles in a dispersed medium. The dispersed medium includes methanol, methyl ethyl ketone, methyl isobutyl ketone, cyclohexanone, N-methyl-2-pyrrolidone, propylene glycol monomethyl ether, ethoxy ethanol, or a combination of the dispersed media.

The commercial titanium dioxide particle of the inorganic particle (G) includes NanoTek TiO₂ (dispersant is methyl isobutyl ketone, anatase type) made by C.I. Kasei Co., Ltd., Lot No.: S111109 (dispersant is ethoxy ethanol, rutile type) made by Nano CMS Co., Ltd., Red Lake series (dispersant is methanol, anatase type) made by JGC Catalysts And Chemicals, or TS series (dispersant is methyl ethyl ketone, rutile type) made by Tayca. The commercial zirconia particle of the inorganic particle (G) includes HXU-120JC (dispersant is ethyl methyl ketone) made by Sumitomo Osaka Cement Co., Ltd.

It should be mentioned that, the inorganic particle (G) can also use silicon dioxide as the major component thereof. In terms of dispersibility, the silanol group on the surface of the silicon dioxide particle is preferably hydrophobized so as to uniformly dispersed in the solvent. The shape of the silicon dioxide particle is not particularly limited, and the shape of the silicon dioxide particle is, for instance, spherical, needle-like, or irregular. In terms of scattered light and security, the shape of the silicon dioxide particle is preferably spherical. In terms of the dispersibility of the silicon dioxide particle in the photosensitive resin composition for a black matrix, the particle size of the silicon dioxide particle is preferably 5 nm to 100 nm and more preferably 10 nm to 100 nm.

Specific examples of the silicon dioxide particle and the dispersion of the silicon dioxide particle include methyl ethyl ketone-dispersed silica sol (MEK-ST made by Nissan Chemical Industries, Ltd. and PL-1-MEK, PL-2-MEK, PL-5-MEK, PL-10-MEK, or PL-2 L-MEK made by Fuso Chemical Co., Ltd.), isopropanol-dispersed silica sol (IPA-ST, IPA-ST-UP, or IPA-ST-ZL made by Nissan Chemical Industries, Ltd. and PL-1-IPA, PL-2-IPA, PL-3-IPA, PL-5-IPA, or PL-10-IPA made by Fuso Chemical Co., Ltd.), propylene glycol monomethyl ether acetate-dispersed silica sol (PGM-ST or PMA-ST made by Nissan Chemical Industries, Ltd. or PL-1-PGME made by Fuso Chemical Co., Ltd.), methyl isobutyl ketone-dispersed silica sol (methyl isobutyl ketone-ST made by Nissan Chemical Industries, Ltd.), ethylene glycol-dispersed silica sol (EG-ST or EG-ST-ZL made by Nissan Chemical Industries, Ltd.), methanol-dispersed silica sol (methanol silica sol or MA-ST-M made by Nissan Chemical Industries, Ltd. or PL-1-MA, PL-2-MA, PL-3-MA, PL-5-MA, or PL-9-MA made by Fuso Chemical Co., Ltd.), n-propyl cellosolve (NPC-ST-30 made by Nissan Chemical Industries, Ltd.), toluene-dispersed silica sol (PL-1-TOL, PL-2-TOL, PL-3-TOL, PL-5-TOL, or PL-10-TOL made by Fuso Chemical Co., Ltd.), dimethyl acetamide-dispersed silica sol (DMAC-ST made by Nissan Chemical Industries, Ltd.), or xylene and butanol mixed solvent-dispersed silica sol (XBA-ST made by Nissan Chemical Industries, Ltd.). Moreover, the particle obtained by performing a hydrophobization treatment on the surface of an aqueous dispersion type silica sol and then dispersing the aqueous dispersion type silica sol in the solvent can also be used. Alternatively, the particle obtained by performing a hydrophobization treatment on the surface of a powdered silica microparticle can be used.

The inorganic particle (G) can be used alone or in multiple combinations.

The inorganic particle (G) is preferably titanium oxide, zirconium oxide, silicon dioxide, or a combination of the inorganic particles.

Moreover, the particle size of the inorganic particle (G) is 1 nm to 100 nm. The measuring method of particle size can be a known measuring method such as measuring through a dynamic light scattering particle (dynamic light scattering (DLS)). The particle size is preferably 1 nm to 50 nm and more preferably 5 nm to 15 nm.

It should be mentioned that, when the black pigment is a conductive solid particle (such as carbon black), since the inorganic particle (G) does not have conductivity, when the photosensitive resin composition for a black matrix uses the cross-linking agent (F) and the inorganic particle (G) at the same time, especially when using the cross-linking agent (F-1) and the inorganic particle (G), after the formed coating film is post-baked, the distance between conductive solid particles can be effectively maintained. As a result, the issue of reduced surface resistance of the cured product (i.e., black matrix) can be further avoided.

### Additive (H)

Under the premise of not affecting the efficacy of the invention, the photosensitive resin composition for a black matrix of the invention can optionally further include an additive (H). Specific examples of the additive (H) include a surfactant, a filler, an adhesion promoter, an antioxidant, an anticoagulant, or other polymers capable of enhancing various properties (such as mechanical properties) other than the alkali-soluble resin (A).

Specific examples of the surfactant include a cationic surfactant, an anionic surfactant, a nonionic surfactant, a amphoteric surfactant, a polysiloxane surfactant, a fluorine series surfactant, or a combination of the surfactants.

Specifically, examples of the surfactant include polyoxyethylene alkyl ethers such as polyoxyethylene lauryl ether, polyoxyethylene stearyl ether, polyoxyethylene oleyl ether, or a similar compound thereof; polyoxyethylene alkyl phenyl ethers such as polyoxyethylene octyl phenyl ether, polyoxyethylene nonyl phenyl ether, or a similar compound thereof; polyethylene glycol diesters such as polyethylene glycol dilaurate, polyethylene glycol stearyl ether, or a similar compound thereof; sorbitan fatty acid esters; fatty acid-modified polyesters; or tertiary amine-modified polyurethanes. The surfactant can be used alone or in multiple combinations.

Specific examples of the surfactant include KP products made by Shin-Etsu Chemical Co., Ltd., SF-8427 products made by Dow Corning Toray Co., Ltd., Polyflow products made by Kyoeisha Chemical Co. Ltd., F-Top products made by Tochem Products Co., Ltd., Megafac products made by DIC Corporation, Fluorade products made by Sumitomo 3M Limited, Asahi Guard products made by Asahi Glass Co., Ltd., or Surflon products made by Asahi Glass Co., Ltd.

Specific examples of the filler include, for instance, glass or aluminum.

Specific examples of the adhesion promoter include vinyltrimethoxysilane, vinyltriethoxysilane, vinyl-tris(2-methoxyethoxy)silane, N-(2-amino ethyl)-3-aminopropylmethyldimethoxysilane, N-(2-aminoethyl)-3-aminopropyltrimethoxysilane, 3-aminopropyltriethoxysilane, 3-glycidoxypropyltrimethoxysilane, 3-glycidoxypropylmethyldiethoxysilane, 2-(3,4-epoxycyclohexypethyltrimethoxysilane, 3-chloropropylmethyldimethoxysilane, 3-chloropropyltrimethoxysilane, 3-methyl propionyloxy propyltrimethoxysilane, 3-mercaptopropyltrimethoxysilane, or a similar compound thereof, or a combination of the compounds.

Specific examples of the antioxidant include 2,2′-thiobis(4-methyl-6-tert-butylphenol), 2 6-di-tert-butylphenol, or a combination of the compounds.

Specific examples of the anticoagulant include, for instance, sodium polyacrylate.

Based on a usage amount of 100 parts by weight of the alkali-soluble resin (A), the range of the usage amount of the polymer other than the filler, the adhesion promoter, the antioxidant, the anticoagulant, and the alkali-soluble resin (A) in the additive (H) is less than 10 parts by weight and preferably less than 6 parts by weight.

### <Preparation Method of Photosensitive Resin Composition for Black Matrix>

The method for preparing the photosensitive resin composition for a black matrix includes, for instance, placing and stirring the alkai-soluble resin (A), the compound (B) having an ethylenically unsaturated group, the photoinitiator (C), the solvent (D), the black pigment (E), the cross-linking agent (F), and the inorganic particle (G) in a stirrer such that the components are uniformly mixed into a solution state. When needed, the additive (H) can be added. After the solution is uniformly mixed, the photosensitive resin composition in a solution state for a black matrix can be obtained.

In addition, the preparation method of the photosensitive resin composition for a black matrix is not particularly limited. The photosensitive resin composition for a black matrix can be formed by directly adding and dispersing the black pigment (E) in the mixture composed of the alkali-soluble resin (A), the compound (B) having an ethylenically unsaturated group, the photoinitiator (C), the solvent (D), the cross-linking agent (F), and the inorganic particle (G). Alternatively, the photosensitive resin composition for a black matrix can also be prepared by first dispersing a portion of the black pigment (E) in a mixture composed of a portion of the alkali-soluble resin (A) and a portion of the solvent (D) to form a pigment dispersion liquid, and then adding the rest of the alkali-soluble resin (A), the compound (B) having an ethylenically unsaturated group, the photoinitiator (C), the solvent (D), the cross-linking agent (F), and the inorganic particle (G). Moreover, the dispersion steps of the black pigment (E) can be performed by mixing with a mixer such as a beads mill or a roll mill. The photosensitive resin composition in solution state for a black matrix can thus be obtained.

### <Preparation Method of Black Matrix>

The black matrix is prepared by applying the treatments of pre-bake, exposure, development, and post-bake to the photosensitive resin composition for a black matrix in sequence. Moreover, when the film thickness of the obtained black matrix is 1 μm, the range of the optical density can be greater than 3.0, preferably 3.2 to 5.5, and more preferably 3.5 to 5.5. The preparation method of the black matrix is described below.

First, the photosensitive resin composition in liquid state for a black matrix is uniformly coated on a substrate by a coating method such as spin coating or cast coating to form a coating film. Specific examples of the substrate include alkali-free glass, soda-lime glass, hard glass (Pyrex glass), silica glass, and glasses with a transparent conductive film attached thereto used for a liquid crystal display. Alternatively, the substrate can be a substrate (such as a silicon substrate) used for a photoelectric conversion device such as a solid imaging device.

After the coating layer is formed, most of the solvent is removed by drying under reduced pressure. Next, the remaining solvent is completely removed by a pre-bake method to form a pre-baked coating film. It should be mentioned that, the conditions for drying under reduced pressure and pre-baking vary according to the type and the ratio of each component. Generally, drying under reduced pressure is performed at a pressure of less than 200 mmHg for 1 second to 20 seconds, and the pre-bake is a heat treatment performed on the coating film at a temperature of 70° C. to 110° C. for 1 minute to 15 minutes.

Then, the pre-baked coating film is exposed with a photomask having a specific pattern. The light used in the exposure process is preferably an ultraviolet light such as a g-line, an h-line, or an i-line. In addition, the UV light irradiation device can be a(n) (ultra-)high pressure mercury vapor lamp or a metal halide lamp.

Then, the exposed pre-baked coating film is immersed in a developing solution at a temperature of 23±2° C. to remove the unexposed portion of the pre-baked coating film and to form a specific pattern on the substrate.

The developing solution is, for instance, an alkali compound such as sodium hydroxide, potassium hydroxide, sodium carbonate, sodium hydrogen carbonate, potassium carbonate, potassium hydrogen carbonate, sodium silicate, sodium methylsilicate, ammonia solution, ethylamine, diethylamine, dimethylethylanolamine, tetramethylammonium hydroxide, tetraethylammonium hydroxide, choline, pyrrole, piperidine, or 1,8-diazabicyclo-(5,4,0)-7-undecene. The concentration of the developing solution is generally 0.001 wt % to 10 wt %, preferably 0.005 wt % to 5 wt %, and more preferably 0.01 wt % to 1 wt %.

After the pre-baked coating film is developed, the substrate having a specific pattern is rinsed with water, and then the specific pattern is air dried with compressed air or compressed nitrogen. Then, a post-bake treatment is performed with a heating device such as a hot plate or an oven. The post-bake temperature is generally 150 to 250° C., wherein the heating time when using the hot plate is 5 minutes to 60 minutes and the heating time when using the oven is 15 minutes to 150 minutes. After the treatment steps, a black matrix can be formed on the substrate.

### <Preparation Method of Pixel Layer and Color Filter>

The color filter is prepared by applying the treatments of pre-bake, exposure, development, and post-bake to a substrate with a black matrix formed thereon with the photosensitive resin composition for a color filter in sequence, and the black matrix is used to isolate each of the pixel layers (the pixel layer is also referred to as a pixel color layer in the following). The preparation method of the color filter is described below.

First, the photosensitive resin composition in liquid state for a color filter is uniformly coated on a substrate by a coating method such as spin coating, cast coating, or roll coating to form a coating film.

After the coating layer is formed, most of the solvent is removed by drying under reduced pressure. Next, the remaining solvent is completely removed by a pre-bake method to form a pre-baked coating film. It should be mentioned that, the conditions for drying under reduced pressure and pre-baking vary according to the type and the ratio of each component. Generally, the drying under reduced pressure is performed at a pressure of 0 mmHg to 200 mmHg for 1 second to 60 seconds, and the pre-bake is a heat treatment performed on the coating film at a temperature of 70° C. to 110° C. for 1 minute to 15 minutes.

Then, the pre-baked coating film is exposed with a photomask having a specific pattern. The light used in the exposure process is preferably an ultraviolet light such as a g-line, an h-line, or an i-line. In addition, the UV light irradiation device can be a(n) (ultra-)high pressure mercury vapor lamp or a metal halide lamp.

Then, the exposed pre-baked coating film is immersed in a developing solution at a temperature of 23+2° C. to remove the unexposed portion of the pre-baked coating film and to form a specific pattern on the substrate.

After the pre-baked coating film is developed, the substrate having a specific pattern is rinsed with water, and then the specific pattern is air dried with compressed air or compressed nitrogen. Then, a post-bake treatment is performed with a heating device such as a hot plate or an oven. The conditions for the post-bake treatment are as described and are not repeated herein. The steps are repeated to form the pixel color layers of, for instance, red, green, and blue on a substrate.

Lastly, in a vacuum environment with a temperature of 220° C. to 250° C., an ITO protective film (evaporated film) is formed on the surface of the pixel color layer by sputtering. When needed, the ITO protective film is etched and wired, and a liquid crystal alignment film (polyimide for a liquid crystal alignment film) is coated on the surface of the ITO protective film to form a color filter having a pixel layer.

### <Preparation Method of Liquid Crystal Display Device>

The liquid crystal display is prepared by oppositely disposing the color filter formed by the forming method of a color filter and a substrate with a thin film transistor (TFT) disposed thereon, and then disposing a gap (cell gap) therebetween. Moreover, the surrounding area of the color filter and the substrate is adhered with an adhesive and an injection hole is left. Then, liquid crystal is injected into the injection hole of the gap separated by the substrate surface and the adhesive. Lastly, the injection hole is sealed to form a liquid crystal layer. Then, the liquid crystal display is fabricated by providing a polarizer to each of the other side of the color filter contacting the liquid crystal layer and the other side of the substrate contacting the liquid crystal layer.

The liquid crystal used, i.e., a liquid crystal compound or a liquid crystal composition, is not particularly limited. In other words, any liquid crystal compound or liquid crystal composition can be used.

Moreover, the liquid crystal alignment film used in the fabrication of the color filter is used to limit the alignment of the liquid crystal molecules and is not particularly limited. Both inorganic matter and organic matter are allowed, but the invention is not limited thereto.

A plurality of embodiments are listed below to explain the application of the invention. However, the embodiments are not used to limit the invention. Those having ordinary skill in the art can make various modifications and variations without departing from the scope and spirit of the invention.

### SYNTHESIS EXAMPLE A-1

In the following, synthesis example A-1-1 to synthesis example A-1-3 of the resin (A-1) having an unsaturated group are described:

### SYNTHESIS EXAMPLE A-1-1

First, 100 parts by weight of a fluorene epoxy compound (i.e. epoxy compound containing fluorene ring) (model number ESF-300, made by Nippon Steel Chemical Co., Ltd., epoxy equivalent 231), 30 parts by weight of acrylic acid, 0.3 parts by weight of benzyltriethylammonium chloride, 0.1 parts by weight of 2,6-di-t-butyl-p-cresol, and 130 parts by weight of propylene glycol monomethyl ether acetate are added in a 500 ml four-neck flask in a continuous manner. The feeding speed is controlled at 25 parts by weight/minute, the temperature of the reaction process is maintained at 100° C. to 110° C., and the mixture is reacted for 15 hours to obtain a light yellow mixture solution having a solid component concentration of 50 wt %.

Then, 100 parts by weight of the obtained light yellow mixture is dissolved in 25 parts by weight of ethylene glycol monoethyl ether acetate, and 6 parts by weight of tetrahydrophthalic anhydride and 13 parts by weight of benzophenone tetracarboxylic dianhydride are added at the same time. Next, the mixture is heated to 110° C. to 115° C. and reacted for 2 hours to obtain the resin A-1-1 having an unsaturated group having an acid value of 98.0 mgKOH/g.

### SYNTHESIS EXAMPLE A-1-2

First, 100 parts by weight of a fluorene epoxy compound (model number ESF-300, made by Nippon Steel Chemical Co., Ltd., epoxy equivalent 231), 30 parts by weight of acrylic acid, 0.3 parts by weight of benzyltriethylammonium chloride, 0.1 parts by weight of 2,6-di-t-butyl-p-cresol, and 130 parts by weight of propylene glycol monomethyl ether acetate are added in a 500 ml four-neck flask in a continuous manner. The feeding speed is controlled at 25 parts by weight/minute, the temperature of the reaction process is maintained at 100° C. to 110° C., and the mixture is reacted for 15 hours to obtain a light yellow mixture solution having a solid component concentration of 50 wt %.

Then, 100 parts by weight of the obtained light yellow mixture is dissolved in 25 parts by weight of ethylene glycol monoethyl ether acetate, and then 13 parts by weight of benzophenone tetracarboxylic dianhydride is added. Next, the mixture is reacted at 90° C. to 95° C. for 2 hours. Then, 6 parts by weight of tetrahydrophthalic anhydride is added, and the mixture is reacted at 90° C. to 95° C. for 4 hours to obtain the resin A-1-2 having an unsaturated group having an acid value of 99.0 mgKOH/g.

### SYNTHESIS EXAMPLE A-1-3

First, 400 parts by weight of an epoxy compound (model number NC-3000, made by Nippon Kayaku Co., Ltd., epoxy equivalent 288), 102 parts by weight of acrylic acid, 0.3 parts by weight of methoxyphenol, 5 parts by weight of triphenylphosphine, and 264 parts by weight of propylene glycol monomethyl ether acetate are placed in a reaction flask. The temperature of the reaction process is maintained at 95° C. and the mixture is reacted for 9 hours to obtain an intermediate product having an acid value of 2.2 mgKOH/g. Then, 151 parts by weight of tetrahydrophthalic anhydride is added. Next, the mixture is reacted at 95° C. for 4 hours to obtain the resin A-1-3 having an unsaturated group having an acid value of 102 mgKOH/g and a weight average molecular weight of 3,200.

### SYNTHESIS EXAMPLE A-2

In the following, synthesis example A-2-1 to synthesis example A-2-2 of the other alkali-soluble resins (A-2) are described:

### SYNTHESIS EXAMPLE A-2-1

First, 1 part by weight of 2,2′-azobisisobutyronitrile, 240 parts by weight of propylene glycol monomethyl ether acetate, 20 parts by weight of methacrylic acid, 15 parts by weight of styrene, 35 parts by weight of benzyl methacrylate, 10 parts by weight of glycerol monomethacrylate, and 20 parts by weight of N-phenylmaleimide are placed in a round-bottom flask provided with a stirrer. Then, a condenser is provided on the round-bottom flask and the round-bottom flask is filled with nitrogen gas. Next, the components are slowly stirred and the temperature is raised to 80° C. such that each of the reactants is uniformly mixed, and then a polymerization reaction is performed for 4 hours. Then, the temperature is further raised to 100° C. and 0.5 parts by weight of 2,2′-azobisisobutyronitrile is added. Next, after performing polymerization for 1 hour, the other alkali-soluble resins A-2-1 can be obtained.

### SYNTHESIS EXAMPLE A-2-2

First, 2 parts by weight of 2,2′-azobisisobutyronitrile, 300 parts by weight of di(propylene glycol) monomethyl ether, 15 parts by weight of methacrylic acid, 15 parts by weight of 2-hydroxyethyl acrylate, and 70 parts by weight of benzyl methacrylate are placed in a round-bottom flask provided with a stirrer. Then, a condenser is provided on the round-bottom flask and the round-bottom flask is filled with nitrogen gas. Next, the components are slowly stirred and the temperature is raised to 80° C. such that each of the reactants is uniformly mixed, and then a polymerization reaction is performed for 3 hours. Then, the temperature is further raised to 100° C. and 0.5 parts by weight of 2,2′-azobisisobutyronitrile is added. Next, after performing polymerization for 1 hour, the other alkali-soluble resins A-2-2 can be obtained.

### SYNTHESIS EXAMPLE (F-1)

In the following, synthesis example F-1-1 and synthesis example F-1-2 of the cross-linking agent (F-1) are described:

### SYNTHESIS EXAMPLE F-1-1

Nitrogen gas is introduced into a flask provided with a thermometer, a dropping funnel, a condenser, and a stirrer, and then 282 parts by weight of β-naphthol is dissolved in 600 parts by weight of methyl isobutyl ketone (hereinafter MIBK) in the flask. Next, 53 parts by weight of 30 wt % sodium hydroxide solution and 67 parts by weight of para-formaldehyde (93%) are added in the flask. Then, the mixture is reacted at 20° C. for 3 hours. After the reaction is complete, 42 parts by weight of hydrochloric acid (35%) is added for neutralization to obtain a reaction solution containing 1-methylol-2-naphthol.

To the obtained reaction solution is added 108 parts by weight of o-cresol and 2 parts by weight of hydrochloric acid (35%). Then, after the reaction solution is maintained at 30° C. for 1 hour, the reaction solution is reacted at 70° C. for 10 hours to obtain a reaction mixture. Next, a rinse treatment is applied to the reaction mixture until the cleaning solution of the reaction mixture is neutral, and MIBK in the oil layer is removed by reduced pressure distillation. In this way, 420 parts by weight of the novolac resin represented by formula (f-1) can be obtained, and the equivalent of the hydroxyl group of the obtained novolac resin is 140 g/eq.

280 parts by weight of the novolac resin and 740 parts by weight of epichlorohydrin are dissolved in 185 parts by weight of dimethyl sulfoxide. Then, the mixture is heated to 40° C. and 82 parts by weight of sodium hydroxide flakes (99% purity) is added over a period of 100 minutes. Next, the mixture is maintained at 50° C. for 2 hours and reacted at 70° C. for 1 hour. The mixture is continuously stirred. After the reaction is complete, the remaining epichlorohydrin is distilled by using a rotary evaporator at 130° C. and 5 mmHg to obtain a residue. Next, the residue is dissolved in 688 parts by weight of MIBK.

Then, the MIBK solution with the residue dissolved therein is heated to 70° C. and 10 parts by weight of 30 wt % aqueous sodium hydroxide is added to react for 1 hour to obtain a reaction solution. Then, the reaction solution is rinsed repeatedly with water 3 times until the pH value is neutral. Next, the aqueous layer is separated and removed, and MIBK is distilled from the oil layer with a rotary evaporator by heating under reduced pressure. In this way, 327 parts by weight of the epoxy resin of synthesis example F-1-1 (i.e., the cross-linking agent synthesized in synthesis example F-1-1) can be obtained.

### SYNTHESIS EXAMPLE F-1-2

Nitrogen gas is introduced into a flask provided with a thermometer, a dropping funnel, a condenser, and a stirrer, and then 282 parts by weight of β-naphthol is dissolved in 600 parts by weight of MIBK in the flask. Next, 53 parts by weight of 30 wt % sodium hydroxide solution and 67 parts by weight of para-formaldehyde (93%) are added in the flask. Then, the mixture is reacted at 20° C. for 3 hours. After the reaction is complete, 42 parts by weight of hydrochloric acid (35%) is added for neutralization to obtain a reaction solution containing 1-methylol-2-naphthol.

To the obtained reaction solution is added 108 parts by weight of p-cresol and 2 parts by weight of hydrochloric acid (35%). Then, after the reaction solution is maintained at 30° C. for 1 hour, the reaction solution is reacted at 70° C. for 10 hours to obtain a reaction mixture. Next, a rinse treatment is applied to the reaction mixture until the cleaning solution of the reaction mixture is neutral, and MIBK in the oil layer is removed by reduced pressure distillation. In this way, 420 parts by weight of the novolac resin represented by formula (f-1) can be obtained, and the equivalent of the hydroxyl group of the obtained novolac resin is 140 g/eq.

280 parts by weight of the novolac resin and 740 parts by weight of epichlorohydrin are dissolved In 185 parts by weight of dimethyl sulfoxide. Then, the mixture is heated to 40° C. and 82 parts by weight of sodium hydroxide flakes (99% purity) is added over a period of 100 minutes. Next, the mixture is maintained at 50° C. for 2 hours and reacted at 70° C. for 1 hour. The mixture is continuously stirred. After the reaction is complete, the remaining epichlorohydrin is distilled by using a rotary evaporator at 130° C. and 5 mmHg to obtain a residue. Next, the residue is dissolved in 688 parts by weight of MIBK.

Then, the MIBK solution with the residue dissolved therein is heated to 70° C. and 10 parts by weight of 30 wt % aqueous sodium hydroxide is added to react for 1 hour to obtain a reaction solution. Then, the reaction solution is rinsed repeatedly with water 3 times until the pH value is neutral. Next, the aqueous layer is separated and removed, and MIBK is distilled from the oil layer with a rotary evaporator by heating under reduced pressure. In this way, 327 parts by weight of the epoxy resin of synthesis example F-1-2 (i.e., the cross-linking agent synthesized in synthesis example F-1-2) can be obtained.

### EXAMPLES

### Example 1

To 1,000 parts by weight of propylene glycol monomethyl ether acetate is added 100 parts by weight of the resin A-1-1 having an unsaturated group, 15 parts by weight of trimethylolpropane triacrylate (composition (B-1) having an ethylenically unsaturated group), 5 parts by weight of 149-ethyl-6-(2-methylbenzoyl)-9H-carbazol-3-yl]-ethanone 1-(O-acetyloxime) (photoinitiator (C-1), product name: OXE-02, made by Ciba Specialty Chemicals Co., Ltd.), 100 parts by weight of MA100 (black pigment (E-1), carbon black, made by Mitsubishi Chemical Corporation), and 1 part by weight of naphthalene-modified epoxy resin (cross-linking agent (F-1-1) and titanium dioxide (inorganic particle (G-1), made by C. I. Kasei Co., Ltd.). Then, a shaking type stirrer is used to uniformly stir the components to obtain the photosensitive resin composition for a black matrix of example 1.

The photosensitive resin composition for a black matrix of example 1 is placed in a coating machine (model number MS-Al 50, purchased from Hsin Kong Trade Co., Ltd.) and then coated on a glass substrate having a dimension of 100 mm×100 mm with a spin coating method to form a coating film. Then, the coating film is dried under reduced pressure at a pressure of 100 mmHg for 5 seconds and pre-baked in an oven at 100° C. for 2 minutes to form a pre-baked coating film having a film thickness of 1.75 μm. Next, the pre-baked coating film is patterned by exposing with an ultraviolet light at 100 mJ/cm² (model number of exposure machine is AG500-4N, made by M&R Nano Technology Co., Ltd.). Then, the substrate having the exposed pre-baked coating film thereon is developed with 0.04% aqueous potassium hydroxide at 23° C. for 2 minutes to remove the unexposed portion of the pre-baked coating film on the substrate.

Next, the glass substrate is rinsed with water. Lastly, the semi-finished product of the black matrix is post-baked in an oven at 230° C. for 30 minutes. Next, the semi-finished product of the black matrix is post-baked at 300° C. for 60 minutes. In this way, the black matrix (also referred to as a light-shielding film, thickness is 1.5 μm) of example 1 can be obtained.

Moreover, the high surface resistance of the black matrix formed by the photosensitive resin composition for a black matrix of example 1 is evaluated, and the result is as shown in Table 2.

### Example 2 to Example 7

The photosensitive resin composition for a black matrix and the black matrix of each of example 2 to example 7 are prepared using the same steps as example 1, with the difference being: the type of the components and the usage amount of the photosensitive resin composition for a black matrix are changed (as shown in Table 2), wherein the compounds corresponding to the labels of Table 2 are as shown in Table 1. Moreover, the high surface resistance of the black matrix formed by the photosensitive resin composition for a black matrix of each of example 2 to example 7 is evaluated, and the results are as shown in Table 2.

TABLE 1

| | |
|---|---|
| B-1 | trimethylolpropane triacrylate |
| B-2 | dipentaerythritol tetracrylate |
| B-3 | dipentaerythritol hexacrylate |
| C-1 | 1-[9-ethyl-6-(2-methylbenzoyl)-9H-carbazol-3-yl]-ethanone 1-(O-acetyloxime) |
| | (product name: OXE-02, made by Ciba Specialty Chemicals Co., Ltd.) |
| C-2 | 1-[4-(phenylthio)phenyl]-octane-1,2-dione 2-(O-benzoyloxime) (product name: |
| | OXE-01, made by Ciba Specialty Chemicals Co., Ltd.) |
| C-3 | 2-methyl-1-[4-(methylthio)phenyl]-2-morpholino-1-propanone (product name: |
| | IRGACURE 907, made by Ciba Specialty Chemicals Co., Ltd.) |
| D-1 | propylene glycol monomethyl ether acetate (PGMEA) |
| D-2 | ethyl 3-ethoxy propionate |
| E-1 | MA100 (carbon black, made by Mitsubishi Chemical Corporation) |
| E-2 | MA230 (carbon black, made by Mitsubishi Chemical Corporation) |
| F-1-1 | cross-linking agent synthesized in synthesis example F-1-1 |
| F-1-2 | cross-linking agent synthesized in synthesis example F-1-2 |
| F-1-3 | ESN-175 (naphthalene-modified epoxy resin, epoxy equivalent: 270, made by |
| | Nippon Steel Chemical Co., Ltd.) |
| F-1-4 | ESN-375 (naphthalene-modified epoxy resin, epoxy equivalent: 270, made by |
| | Nippon Steel Chemical Co., Ltd.) |
| F-1-5 | NC-7300L (naphthalene-modified epoxy resin, made by Nippon Kayaku Co., Ltd.) |
| F-2-1 | ECN1273 (novolac epoxy resin, made by Ciba Specialty Chemicals Co., Ltd.) |
| F-2-2 | Epikote 157S70 (bisphenol A epoxy resin, made by Yuka Shell Epoxy Co., Ltd.) |
| G-1 | NanoTek TiO₂ (titanium dioxide, made by C.I. Kasei Co., Ltd.) |
| G-2 | HXU-120JC (zirconium dioxide, made by Sumitomo Osaka Cement) |
| G-3 | MEK-ST (silicon dioxide, made by Nissan Chemical Industries, Ltd.) |
| H-1 | SF-8427(made by Dow Corning Toray Co., Ltd., surfactant) |
| H-2 | 3-glycidoxypropyltrimethoxysilane (product name KBM403, made by Shin-Etsu |
| | Chemical Co., Ltd., coupling agent) |

### Comparative Examples

### Comparative Example 1 to Comparative Example 5

The photosensitive resin composition for a black matrix and the black matrix of each of comparative example 1 to comparative example 5 are prepared using the same steps as example 1, with the difference being: the type of the components and the usage amount of the photosensitive resin composition for a black matrix are changed (as shown in Table 3), wherein the compounds corresponding to the labels of Table 3 are as shown in Table 1. Moreover, the high surface resistance of the black matrix formed by the photosensitive resin composition for a black matrix of each of comparative example 1 to comparative example 5 is evaluated, and the results are as shown in Table 3.

### [Evaluation of Surface Resistance]

Each of the black matrices (i.e., post-baked coating films) having a film thickness of 1.5 μm is measured by using a high resistance meter (model number MCP-HT450, model Hiresta-UP, made by Mitsubishi Chemical Corporation). Three random measurement points are selected on the post-baked coating film and the average value (Ωₛ) of surface resistance is measured.

⊚: Ω_{S}≧1.0×10¹⁰

◯: 1.0×10⁷≦Ω_{S}<1.0×10¹⁰

Δ: 1.0×10⁶≦Ω_{S}<1.0×10⁷

×: Ω_{S}<1.0×10⁶

### <Evaluation Results>

Please refer to Table 2 and Table 3. The novolac resin (A) of comparative example 1 does not contain the resin (A-1) having an unsaturated group and the surface resistance of the black matrix of comparative example 1 is worse. In comparison, the novolac resin (A) of each of example 1 to example 7 contains the resin (A-1) having an unsaturated group and the surface resistance of the black matrix is better. Accordingly, when the novolac resin (A) contains the resin (A-1) having an unsaturated group having better heat resistance, the surface resistance of the black matrix is better.

The photosensitive resin composition for a black matrix of comparative example 2 does not contain the cross-linking agent (F) and the surface resistance is worse. Moreover, although the photosensitive resin composition for a black matrix of comparative example 4 contains the cross-linking agent (F), the cross-linking agent (F) does not contain the cross-linking agent (F-1) and only contains the cross-linking agent (F-2) (novolac epoxy resin). Moreover, the surface resistance of the black matrix of comparative example 2 is worse. In comparison, the photosensitive resin composition for a black matrix of each of example 1 to example 7 contains the cross-linking agent (F), and the cross-linking agent (F) contains the cross-linking agent (F-1). Moreover, the surface resistance of the black matrix of each of example 1 to example 7 is better. Accordingly, when the photosensitive resin composition for a black matrix contains the cross-linking agent (F) and the cross-linking agent (F) contains the cross-linking agent (F-1), the surface resistance of the black matrix is better. It should be mentioned that, when the usage amount of the cross-linking agent (F-1) of each of example 2 to example 6 is 2 parts by weight to 20 parts by weight, the surface resistance of the black matrix is better.

The photosensitive resin composition for a black matrix of comparative example 3 does not contain the inorganic particle (G), and the surface resistance is worse. In comparison, the cross-linking agent (F) of each of example 1 to example 7 contains the inorganic particle (G) and the surface resistance is better. Accordingly, when the photosensitive resin composition for a black matrix contains the inorganic particle (G), the surface resistance of the black matrix is better.

The photosensitive resin composition for a black matrix of comparative example 5 does not contain the resin (A-1) having an unsaturated group, the cross-linking agent (F-1), and the inorganic particle (G), and therefore the surface resistance of the black matrix is worse.

TABLE 2

| | | | Examples | | | | | | |
|---|---|---|---|---|---|---|---|---|---|
| Components | | | 1 | 2 | 3 | 4 | 5 | 6 | 7 |
| alkai-soluble resin (A) | A-1 | A-1-1 | 100 | — | — | 50 | 30 | — | — |
| (parts by weight) | | A-1-2 | — | 100 | — | 50 | — | 50 | — |
| | | A-1-3 | — | — | 100 | — | — | — | 70 |
| | A-2 | A-2-1 | — | — | — | — | 70 | 50 | — |
| | | A-2-2 | — | — | — | — | — | — | 30 |
| compound (B) having an | B-1 | | 15 | — | — | 100 | — | 100 | 180 |
| ethylenically unsaturated | B-2 | | | 30 | — | — | 120 | — | — |
| group (parts by weight) | B-3 | | — | — | 60 | — | — | 50 | |
| photoinitiator (C) | C-1 | | 5 | — | 15 | — | 40 | — | — |
| (parts by weight) | C-2 | | — | 10 | — | 30 | — | 50 | — |
| | C-3 | | — | — | 5 | — | — | — | 60 |
| organic solvent (D) | D-1 | | 1,000 | — | 2,000 | 1,000 | 4,000 | — | 3,000 |
| (parts by weight) | D-2 | | — | 1,500 | — | 2,000 | — | 5,000 | 2,000 |
| black pigment (E) | E-1 | | 100 | — | 250 | — | 450 | 400 | — |
| (parts by weight) | E-2 | | — | 150 | — | 300 | — | 200 | 800 |
| cross-linking agent (F) | F-1 | F-1-1 | 1 | — | — | — | — | — | — |
| (parts by weight) | | F-1-2 | — | 2 | — | — | — | — | — |
| | | F-1-3 | — | — | — | 10 | — | — | 30 |
| | | F-1-4 | — | — | — | — | 15 | — | — |
| | | F-1-5 | — | — | 6 | — | — | 20 | — |
| | F-2 | F-2-1 | 1 | — | — | — | — | — | — |
| | | F-2-2 | — | — | — | — | 15 | — | — |

| | | | | | | | | |
|---|---|---|---|---|---|---|---|---|
| inorganic particle (G) | G-1 | 3 | — | — | 15 | — | — | 25 |
| (parts by weight) | G-2 | — | 5 | — | — | 20 | — | — |
| | G-3 | — | — | 9 | — | — | 25 | 5 |
| additive (H) | H-1 | — | 1 | — | — | — | — | — |
| (parts by weight) | H-2 | — | — | — | 2 | — | — | — |
| Evaluation results | surface | ◯ | ⊚ | ⊚ | ⊚ | ⊚ | ⊚ | ◯ |
| | resistance | | | | | | | |

TABLE 3

| | | | Comparative examples | | | | |
|---|---|---|---|---|---|---|---|
| Components | | | 1 | 2 | 3 | 4 | 5 |
| alkai-soluble resin (A) | A-1 | A-1-1 | — | 100 | — | — | — |
| (parts by weight) | | A-1-2 | — | — | 100 | — | — |
| | | A-1-3 | — | — | — | 100 | — |
| | A-2 | A-2-1 | 100 | — | — | — | — |
| | | A-2-2 | — | — | — | — | 100 |
| compound (B) having an | B-1 | | 100 | — | — | 150 | — |
| ethylenically unsaturated | B-2 | | — | 120 | — | — | 120 |
| group (parts by weight) | B-3 | | — | — | 100 | — | — |
| photoinitiator (C) | C-1 | | 30 | — | — | 20 | — |
| (parts by weight) | C-2 | | — | 40 | — | — | 30 |
| | C-3 | | — | — | 30 | — | — |
| organic solvent (D) | D-1 | | 2,000 | 1,000 | 2,000 | 2,000 | 4,000 |
| (parts by weight) | D-2 | | — | 2,000 | — | — | — |
| black pigment (E) | E-1 | | 250 | — | 250 | 300 | — |
| (parts by weight) | E-2 | | — | 300 | — | — | 400 |
| cross-linking agent (F) | F-1 | F-1-1 | 10 | — | — | — | — |
| (parts by weight) | | F-1-2 | — | — | — | — | — |
| | | F-1-3 | — | — | — | — | — |
| | | F-1-4 | — | — | 10 | — | — |
| | | F-1-5 | — | — | — | — | — |
| | F-2 | F-2-1 | — | — | — | 15 | — |
| | | F-2-2 | — | — | — | — | 20 |

| | | | | | | |
|---|---|---|---|---|---|---|
| inorganic particle (G) | G-1 | 10 | — | — | — | — |
| | G-2 | — | 15 | — | — | — |
| | G-3 | — | — | — | 20 | — |
| additive (H) | H-1 | — | — | — | — | — |
| | H-2 | — | — | — | — | — |
| Evaluation results | surface | X | X | X | X | X |
| | resistance | | | | | |

Based on the above, in the invention, by using the resin (A) having an unsaturated group and the cross-linking agent (F) as the components of the photosensitive resin composition for a black matrix, the heat resistance of the photosensitive resin composition for a black matrix can be effectively increased to prevent the issue of low surface resistance of the black matrix. Moreover, the inorganic particle (G) can effectively maintain the distance between the solid particles of the black pigment, and therefore the issue of low surface resistance of the black matrix can also be avoided.

Although the invention has been described with reference to the above embodiments, it will be apparent to one of the ordinary skill in the art that modifications to the described embodiments may be made without departing from the spirit of the invention. Accordingly, the scope of the invention is defined by the attached claims not by the above detailed descriptions.

What is claimed is:

1. A photosensitive resin composition for a black matrix, comprising:
an alkali-soluble resin (A) comprising a resin (A-1) having an unsaturated group, wherein the resin (A-1) having an unsaturated group is obtained by polymerizing a mixture, and the mixture comprising an epoxy compound (a-1-1) having at least two epoxy groups and a compound (a-1-2) having at least one carboxylic acid group and at least one ethylenically unsaturated group;
a compound (B) having an ethylenically unsaturated group
a photoinitiator (C);
a solvent (D);
a black pigment (E);
a cross-linking agent (F) comprising a cross-linking agent (F-1), wherein the cross-linking agent (F-1) is obtained by reacting a novolac resin represented by formula (f-1) and epihalohydrin under an existence of an alkali metal hydroxide; 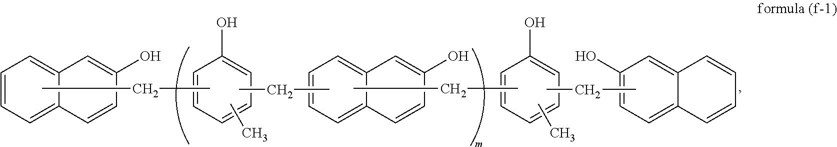
in formula (f-1), m represents an integer of 0 to 7; and
an inorganic particle (G) employing oxides of a Group 4 element, oxides of silicone, or a combination thereof to serve as a major component.

2. The photosensitive resin composition for a black matrix of claim 1, wherein the epoxy compound (a-1-1) having at least two epoxy groups comprises a structure shown in formula (a-1), a structure shown in formula (a-2), or a combination of the two structures, 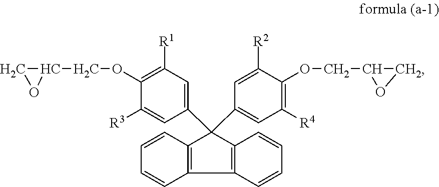
in formula (a-1), R¹, R², R³, and R⁴ each independently represent a hydrogen atom, a halogen atom, a C₁-C₅ alkyl group, a C₁-C₅ alkoxy group, a C₆-C₁₂ aryl group, or a C₆-C₁₂ aralkyl group, 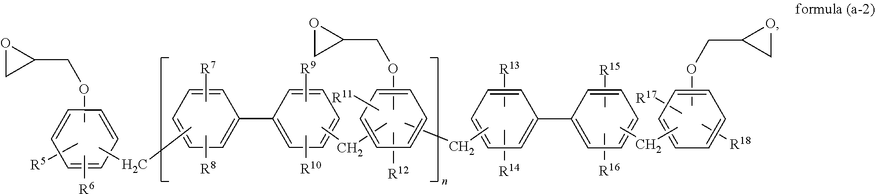
in formula (a-2), R⁵ to R¹⁸ each independently represent a hydrogen atom, a halogen atom, a C₁-C₈ alkyl group, or a C₆-C₁₅ aromatic group, and n represents an integer of 0 to 10.

3. The photosensitive resin composition for a black matrix of claim 1, wherein based on 100 parts by weight of the alkali-soluble resin (A), a usage amount of the compound (B) having an ethylenically unsaturated group is 15 to 180 parts by weight, a usage amount of the photoinitiator (C) is 5 to 60 parts by weight, a usage amount of the solvent (D) is 1,000 to 5,000 parts by weight, a usage amount of the black pigment (E) is 100 to 800 parts by weight, a usage amount of the cross-linking agent (F) is 2 to 30 parts by weight, and a usage amount of the inorganic particle (G) is 3 to 30 parts by weight.

4. The photosensitive resin composition for a black matrix of claim 1, wherein based on 100 parts by weight of the alkali-soluble resin (A), a usage amount of the cross-linking agent (F-1) is 2 to 20 parts by weight.

5. A black matrix made of the photosensitive resin composition for a black matrix of claim 1.

6. A color filter comprising the black matrix of claim 5.

7. A liquid crystal display comprising the color filter of claim 6.
